(19) United States
(12) Patent Application Publication
(10) Pub. No.: US 2014/0044281 A1
(43) Pub. Date: Feb. 13, 2014

(54) WIRELESSLY POWERED AUDIO DEVICES

(71) Applicant: WiTricity Corporation, Watertown, MA (US)

(72) Inventors: Steven J. Ganem, Westwood, MA (US); Hiroshi A. Mendoza, San Francisco, CA (US); Morris P. Kesler, Bedford, MA (US); Konrad J. Kulikowski, Denver, CO (US); Andre B. Kurs, Chestnut Hill, MA (US); Alexander P. McCauley, Cambridge, MA (US); Eric R. Giler, Boston, MA (US); Katherine L. Hall, Arlington, MA (US); Gozde Guckaya, Belmont, MA (US)

(73) Assignee: WITRICITY CORPORATION, Watertown, MA (US)

(21) Appl. No.: 14/056,335

(22) Filed: Oct. 17, 2013

Related U.S. Application Data
(63) Continuation-in-part of application No. 12/567,716, filed on Sep. 25, 2009, now Pat. No. 8,461,719.
(60) Provisional application No. 61/173,747, filed on Apr. 29, 2009.
(60) Provisional application No. 61/100,721, filed on Sep. 27, 2008.
(60) Provisional application No. 61/108,743, filed on Oct. 27, 2008.
(60) Provisional application No. 61/147,386, filed on Jan. 26, 2009.
(60) Provisional application No. 61/152,086, filed on Feb. 12, 2009.
(60) Provisional application No. 61/178,508, filed on May 15, 2009.
(60) Provisional application No. 61/182,768, filed on Jun. 1, 2009.
(60) Provisional application No. 61/121,159, filed on Dec. 9, 2008.
(60) Provisional application No. 61/142,977, filed on Jan. 7, 2009.
(60) Provisional application No. 61/142,885, filed on Jan. 6, 2009.
(60) Provisional application No. 61/142,796, filed on Jan. 6, 2009.
(60) Provisional application No. 61/142,880, filed on Jan. 6, 2009.
(60) Provisional application No. 61/142,818, filed on Jan. 6, 2009.
(60) Provisional application No. 61/142,887, filed on Jan. 6, 2009.
(60) Provisional application No. 61/156,764, filed on Mar. 2, 2009.
(60) Provisional application No. 61/143,058, filed on Jan. 7, 2009.
(60) Provisional application No. 61/152,390, filed on Feb. 13, 2009.
(60) Provisional application No. 61/163,695, filed on Mar. 26, 2009.
(60) Provisional application No. 61/172,633, filed on Apr. 24, 2009.
(60) Provisional application No. 61/169,240, filed on Apr. 14, 2009.
(60) Provisional application No. 61/714,996, filed on Oct. 17, 2012.
(60) Provisional application No. 61/825,942, filed on May 21, 2013.

(51) Int. Cl. H04R 3/00; H02J 17/00; H02J 7/00; H04R 25/00

(52) U.S. Cl. CPC H04R 3/00; H04R 25/554; H02J 17/00; H02J 7/0013
USPC 381/94.6; 381/384; 381/323

(57) ABSTRACT

Techniques herein provide wireless energy transfer to audio devices such as headphones, headsets, hearing aids, and the like. Audio devices are integrated with a device resonator. The device resonator may be positioned and oriented to reduce interaction with lossy or sensitive components of the audio device. A repeater resonator and/or a source resonator is integrated into a headrest of a seat or a chair providing continuous power to the headphones while in use. The audio devices may be recharged wirelessly when positioned near source resonators that may be embedded in pads, tables, carrying cases, cups, and the like.

### CROSS-REFERENCE TO RELATED APPLICATIONS

This application is a continuation-in-part of U.S. patent application Ser. No. 12/567,716 filed Sep. 25, 2009 which claims the benefit of the following U.S. Provisional patent applications: U.S. App. No. 61/100,721 filed Sep. 27, 2008; U.S. App. No. 61/108,743 filed Oct. 27, 2008; U.S. App. No. 61/147,386 filed Jan. 26, 2009; U.S. App. No. 61/152,086 filed Feb. 12, 2009; U.S. App. No. 61/178,508 filed May 15, 2009; U.S. App. No. 61/182,768 filed Jun. 1, 2009; U.S. App. No. 61/121,159 filed Dec. 9, 2008; U.S. App. No. 61/142,977 filed Jan. 7, 2009; U.S. App. No. 61/142,885 filed Jan. 6, 2009; U.S. App. No. 61/142,796 filed Jan. 6, 2009; U.S. App. No. 61/142,889 filed Jan. 6, 2009; U.S. App. No. 61/142,880 filed Jan. 6, 2009; U.S. App. No. 61/142,818 filed Jan. 6, 2009; U.S. App. No. 61/142,887 filed Jan. 6, 2009; U.S. App. No. 61/156,764 filed Mar. 2, 2009; U.S. App. No. 61/143,058 filed Jan. 7, 2009; U.S. App. No. 61/152,390 filed Feb. 13, 2009; U.S. App. No. 61/163,695 filed Mar. 26, 2009; U.S. App. No. 61/172,633 filed 24, 2009; U.S. App. No. 61/169,240 filed Apr. 14, 2009, U.S. App. No. 61/173,747 filed Apr. 29, 2009.

This application also claims the benefit of priority to U.S. Provisional Patent Application No. 61/714,996 filed Oct. 17, 2012 titled “Wireless headphones” and to U.S. Provisional Patent Application No. 61/825,942 filed May 21, 2013 titled “Wirelessly powered hearing aid”. Each of the foregoing applications are incorporated herein by reference in their entirety

### BACKGROUND

This disclosure relates to wireless energy transfer, methods, systems and apparati to accomplish such transfer, and applications.

Audio devices such as headphones, personal speakers, headsets, and the like require electrical energy to produce an audio output or provide noise cancellation. The electrical energy for such devices is usually delivered from disposable batteries and/or a wired connection to an energy source such as a stereo, mobile device, or a music player. Existing methods reduce the utility, comfort, and convenience of the audio devices for many applications. Headphones, for example, are worn on the user's head or neck area which often limits the weight and/or size of the devices and may limit the size of the batteries that may be comfortably tolerated by the user. Smaller batteries result in shorter use windows or frequent replacement and/or recharging of the batteries. Cables that tether the audio devices to power sources may limit the mobility of the audio devices and may pose a tangling hazard and limit the reliability of the audio devices. These limitations are magnified when considering venues and or environments for which hundreds or thousands of person-worn devices are worn or used. Theaters, airplanes, work environments, and the like, that may rely on person audio devices may need to accommodate battery supplies and chargers for the devices and/or mitigate the consequences of reduced mobility and reliability due to cables. Methods that reduce or eliminate the need for batteries or cabled sources for energy would increase the utility and convenience of the devices in many applications.

In addition to the audio devices described above, wireless energy transfer may be used to recharge the batteries of small audio devices without having to remove the batteries. BlueTooth and Jawbone headsets may benefit from this technology because the connected used to recharge the batteries using a wired solution may be eliminated, making the headsets more compact and allowing for new designs that are unconstrained by the presence of the electrical connector. In addition, hearing aids may be recharged by simply placing them on a charging mat or in a charging bowl or enclosure or region. Wireless recharging may eliminate the need for an accessible battery compartment in the hearing aid, which will make it easier for uses to keep the devices charged and may also make it easier to clean and maintain the devices.

### SUMMARY

Techniques herein attempt to provide wireless energy transfer to audio devices such as headphones, headsets, and the like. In some embodiments, audio devices are integrated with a device resonator. The device resonator may be positioned and oriented to reduce interaction with lossy or sensitive components of the audio device. In an example of headphones, a repeater resonator and/or a source resonator may be integrated into a headrest of a seat or a chair providing continuous power to the headphones while in use. In other embodiments, the audio devices may be recharged wirelessly when positioned near source resonators that may be embedded in pads, tables, carrying cases, cups, and the like.

In embodiments a wirelessly powered audio device includes an audio output element; the audio output element may be configured to generate sounds audible by a user. The audio device may further include a device resonator structure wherein the device resonator structure may be configured to wirelessly receive energy via oscillating magnetic fields. In some embodiments the device resonator may be configured to reduce the interaction of the magnetic fields with the audio output element. A power demand monitor may also be included. The power demand monitor may be configured to monitor the power demands of the audio device and the power received via the device resonator structure and to cause the audio output element to generate an audible signal when the power demands of the audio device exceed the power delivered by the device resonator. In some embodiments the device resonator may be positioned near the audio output element such that the device resonator has a relatively high perturbed-Q. In the embodiments where the audio output element includes a solenoid coil, the resonator may be positioned such that the dipole moment of the resonator structure is orthogonal to the dipole moment of the solenoid. In some embodiments magnetic material and/or electrical conductors may be used to shield the audio output element from the magnetic fields near the device resonator structure. The audio device may also include rechargeable batteries and the energy captured by the device resonator may be used to recharge the batteries.

In some embodiments a method for wirelessly powering of an audio device includes the step of initiating wireless energy transfer from a wireless energy source. The method further includes monitoring, using a power demand monitor, a power demand of the audio device and monitoring, using a noise monitor, the noise of an audio signal due to the wireless energy transfer. Based on the power demands, energy transfer may be adjusted to a minimum level that satisfies the power demand of the audio device. The noise of the audio signal may be filtered.

### BRIEF DESCRIPTION OF FIGURES

FIG. 1 is a system block diagram of wireless energy transfer configurations.

FIGS. 2A-2F are exemplary structures and schematics of simple resonator structures.

FIG. 3 is a block diagram of a wireless source with a single-ended amplifier.

FIG. 4 is a block diagram of a wireless source with a differential amplifier.

FIGS. 5A and 5B are block diagrams of sensing circuits.

FIGS. 6A, 6B, and 6C are block diagrams of a wireless source.

FIGS. 7A-B are diagram showing two resonator configurations with repeater resonators.

FIGS. 8A-B are diagram showing two resonator configurations with repeater resonators.

FIG. 9A is a diagram showing a configuration with two repeater resonators 9B is a diagram showing a resonator configuration with a device resonator acting as a repeater resonator.

FIG. 10 is a diagram of a system utilizing a repeater resonator with a desk environment.

FIG. 11 is a diagram of a system utilizing a resonator that may be operated in multiple modes.

FIG. 12 is a circuit block diagram of the power and control circuitry of a resonator configured to have multiple modes of operation.

FIG. 13 is a diagram of an embodiment of a system with wirelessly powered audio devices.

FIG. 14 is a diagram of an embodiment of a system with wirelessly powered audio devices.

FIG. 15 is a diagram of an embodiment of headphones configured for wirelessly powered.

FIG. 16 is an exploded view of an embodiment of headphones configured to receive wireless power.

FIG. 17 is a diagram of a device resonator coil configured to fit into a cup of a headphone.

FIG. 18 is a block diagram of a wirelessly powered audio device.

FIG. 19 is diagram of a process for controlling wireless energy transfer in an audio device.

FIG. 20 is a diagram of a charging configuration.

FIG. 21 is a diagram of a wireless hands free headset configured for wireless energy transfer.

FIG. 22 is a diagram of a charging configuration.

FIG. 23 is a diagram of a device resonator coil configured for a hands free headset.

FIG. 24 is a diagram of a source resonator coil.

FIG. 25 is a block diagram of a wirelessly powered hearing aid system.

FIG. 26 is a diagram of an embodiment of a device resonator and a source resonator.

FIG. 27 is a block diagram of a wirelessly powered hearing aid system.

FIG. 28A is a graph showing coil-to-coil efficiency (%) as the source coil size is varied. FIG. 28B is a graph showing coupling factor, k, as the source coil size is varied.

### DETAILED DESCRIPTION

Audio devices may be powered and/or recharged wirelessly. Audio devices such as headphones, headsets, hands free headsets, phone headsets, and/or other audio devices may be wirelessly powered while worn or used by the user. In some embodiments, the audio devices may be wirelessly recharged and/or powered when not in use, when stored or positioned or placed in a holder, carrying case, basket, and/or the like.

Audio devices that are wirelessly powered and/or charged may, in many embodiments, be completely wireless with both data (i.e. music or other audio data) and power transmitted wirelessly. Data may be transmitted using wireless data transmission protocols such as Bluetooth, WiFi, FM, Infrared, and/or other protocols and technologies. Power may be transmitted to the devices via highly coupled resonant wireless energy transfer.

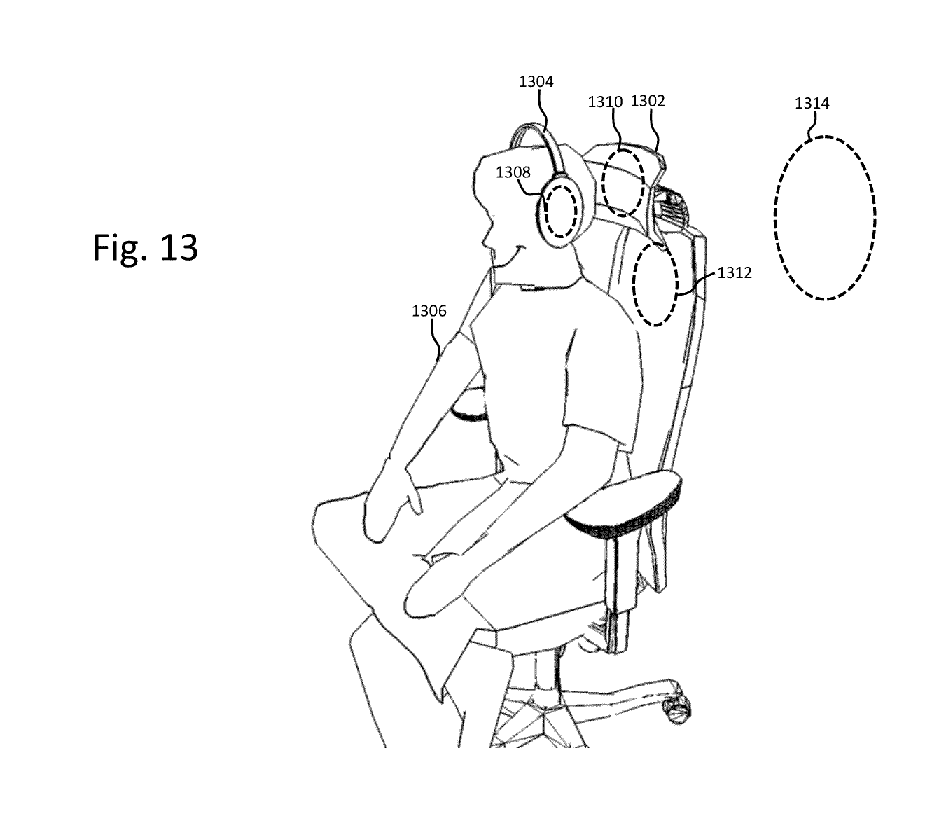

Resonators, configured for wireless energy transfer may be integrated or attached to the audio devices. The resonators may receive energy via oscillating magnetic fields from source and/or repeater resonators that may be embedded or attached to furniture, televisions, monitors, walls, ceilings, chairs, and the like. For example, one example embodiment of a system with wirelessly powered headphones is shown in FIG. 13. The figure shows a system in which a pair of headphones 1304 worn by a user 1306 may be wirelessly powered and/or charged while in use by the user. The user may wear the headphones while the headphones wirelessly receive audio data and energy. In the example embodiment a source resonator 1310, generating an oscillating magnetic field may be attached or integrated into the headrest 1302 of the chair. The oscillating magnetic fields may be captured by one or more device resonators 1308 that are attached and/or integrated into the headphone devices. The energy stored in the oscillating magnetic field may be transformed into electrical energy and used to power the headphones and/or charge the internal batteries of the device. The headphones may therefore be used indefinitely without wires or the need to replace batteries. Likewise, the headphones may not require any wires or cables that may inhibit movement or mobility. Such headphones may not need any electrical connectors or connections which may be failure prone and may reduce the usability and/or lifetime of the headphones.

The ability to indefinitely power a set of headphones may be better appreciated when considering use environments such as airplanes, for example. Headphones are an integral part of an airplane's entertainment system that keeps passengers occupied and entertained on long flights. Traditional battery operated headphones may not be practical since the batteries of such devices may need to be replaced for every flight. Wired headphones, while less expensive, may cause a potential safety problem. In an emergency, passengers may need to disembark the airplane as quickly as possible with many of the passengers having to scoot or make their way through a row of seats to get to an aisle. Wired headphones left by passengers may create a dangerous tangle of wires and trap panicked passengers, for example. The safety and practical concerns may be solved by the embodiments of the invention described herein. Source and/or repeater resonators may be integrated into the seats, ceilings, walls, floor, windows, and the like of the airplane. The source and repeater resonators may generate oscillating magnetic fields that may be captured by the resonators attached or embedded to the headphones allowing the headphones to be powered wirelessly, without a potential tangle of wires.

The devices, methods, and systems that may be used to enable wireless energy transfer to audio devices such as headphones are described herein.

Wireless Enemy Transfer

Wireless energy transfer systems described herein may be implemented using a wide variety of resonators and resonant objects.

As those skilled in the art will recognize, important considerations for resonator-based power transfer include resonator efficiency and resonator coupling. Extensive discussion of such issues, e.g., coupled mode theory (CMT), coupling coefficients and factors, quality factors (also referred to as Q-factors), and impedance matching is provided, for example, in U.S. patent application Ser. No. 12/789,611 published on Sep. 23, 2010 as US 20100237709 and entitled “RESONATOR ARRAYS FOR WIRELESS ENERGY TRANSFER,” and U.S. patent application Ser. No. 12/722,050 published on Jul. 22, 2010 as US 20100181843 and entitled “WIRELESS ENERGY TRANSFER FOR REFRIGERATOR APPLICATION” and incorporated herein by reference in its entirety as if fully set forth herein.

A resonator may be defined as a resonant structure that can store energy in at least two different forms, and where the stored energy oscillates between the two forms. The resonant structure will have a specific oscillation mode with a resonant (modal) frequency, f, and a resonant (modal) field. The angular resonant frequency, ω, may be defined as [symbol] , the resonant period, T, may be defined as T=1/f=2π/ω, and the resonant wavelength, λ, may be defined as λ=c/f, where c is the speed of the associated field waves (light, for electromagnetic resonators). In the absence of loss mechanisms, coupling mechanisms or external energy supplying or draining mechanisms, the total amount of energy stored by the resonator, W, would stay fixed, but the form of the energy would oscillate between the two forms supported by the resonator, wherein one form would be maximum when the other is minimum and vice versa.

For example, a resonator may be constructed such that the two forms of stored energy are magnetic energy and electric energy. Further, the resonator may be constructed such that the electric energy stored by the electric field is primarily confined within the structure while the magnetic energy stored by the magnetic field is primarily in the region surrounding the resonator. In other words, the total electric and magnetic energies would be equal, but their localization would be different. Using such structures, energy exchange between at least two structures may be mediated by the resonant magnetic near-field of the at least two resonators. These types of resonators may be referred to as magnetic resonators.

An important parameter of resonators used in wireless power transmission systems is the Quality Factor, or Q-factor, or Q, of the resonator, which characterizes the energy decay and is inversely proportional to energy losses of the resonator. It may be defined as Q=ω*W/P, where P is the time-averaged power lost at steady state. That is, a resonator with a high-Q has relatively low intrinsic losses and can store energy for a relatively long time. Since the resonator loses energy at its intrinsic decay rate, 2Γ, its Q, also referred to as its intrinsic Q, is given by [symbol] . The quality factor also represents the number of oscillation periods, T, it takes for the energy in the resonator to decay by a factor of e^{-2π}. Note that the quality factor or intrinsic quality factor or Q of the resonator is that due only to intrinsic loss mechanisms. The Q of a resonator connected to, or coupled to a power generator, g, or load, l, may be called the “loaded quality factor” or the “loaded Q”. The Q of a resonator in the presence of an extraneous object that is not intended to be part of the energy transfer system may be called the “perturbed quality factor” or the “perturbed Q”.

Resonators, coupled through any portion of their near-fields may interact and exchange energy. The efficiency of this energy transfer can be significantly enhanced if the resonators operate at substantially the same resonant frequency. By way of example, but not limitation, imagine a source resonator with Qₛ and a device resonator with Q_{d}. High-Q wireless energy transfer systems may utilize resonators that are high-Q. The Q of each resonator may be high. The geometric mean of the resonator Q's,

$$\sqrt{\sqrt{{Q}_{s} {Q}_{d}}}$$

may also or instead be high.

The coupling factor, k, is a number between 0≦|k|≦1, and it may be independent (or nearly independent) of the resonant frequencies of the source and device resonators, when those are placed at sub-wavelength distances. Rather the coupling factor k may be determined mostly by the relative geometry and the distance between the source and device resonators where the physical decay-law of the field mediating their coupling is taken into account. The coupling coefficient used in CMT, κ=k\sqrt{ωₛω_{d}}/2, may be a strong function of the resonant frequencies, as well as other properties of the resonator structures. In applications for wireless energy transfer utilizing the near-fields of the resonators, it is desirable to have the size of the resonator be much smaller than the resonant wavelength, so that power lost by radiation is reduced. In some embodiments, high-Q resonators are sub-wavelength structures. In some electromagnetic embodiments, high-Q resonator structures are designed to have resonant frequencies higher than 100 kHz. In other embodiments, the resonant frequencies may be less than 1 GHz.

In exemplary embodiments, the power radiated into the far-field by these sub wavelength resonators may be further reduced by lowering the resonant frequency of the resonators and the operating frequency of the system. In other embodiments, the far field radiation may be reduced by arranging for the far fields of two or more resonators to interfere destructively in the far field.

In a wireless energy transfer system a resonator may be used as a wireless energy source, a wireless energy capture device, a repeater or a combination thereof. In embodiments a resonator may alternate between transferring energy, receiving energy or relaying energy. In a wireless energy transfer system one or more magnetic resonators may be coupled to an energy source and be energized to produce an oscillating magnetic near-field. Other resonators that are within the oscillating magnetic near-fields may capture these fields and convert the energy into electrical energy that may be used to power or charge a load thereby enabling wireless transfer of useful energy.

The so-called “useful” energy in a useful energy exchange is the energy or power that must be delivered to a device in order to power or charge it at an acceptable rate. The transfer efficiency that corresponds to a useful energy exchange may be system or application-dependent. For example, high power vehicle charging applications that transfer kilowatts of power may need to be at least 80% efficient in order to supply useful amounts of power resulting in a useful energy exchange sufficient to recharge a vehicle battery without significantly heating up various components of the transfer system. In some consumer electronics applications, a useful energy exchange may include any energy transfer efficiencies greater than 10%, or any other amount acceptable to keep rechargeable batteries “topped off” and running for long periods of time. In implanted medical device applications, a useful energy exchange may be any exchange that does not harm the patient but that extends the life of a battery or wakes up a sensor or monitor or stimulator. In such applications, 100 mW of power or less may be useful. In distributed sensing applications, power transfer of microwatts may be useful, and transfer efficiencies may be well below 1%.

A useful energy exchange for wireless energy transfer in a powering or recharging application may be efficient, highly efficient, or efficient enough, as long as the wasted energy levels, heat dissipation, and associated field strengths are within tolerable limits and are balanced appropriately with related factors such as cost, weight, size, and the like.

The resonators may be referred to as source resonators, device resonators, first resonators, second resonators, repeater resonators, and the like. Implementations may include three (3) or more resonators. For example, a single source resonator may transfer energy to multiple device resonators or multiple devices. Energy may be transferred from a first device to a second, and then from the second device to the third, and so forth. Multiple sources may transfer energy to a single device or to multiple devices connected to a single device resonator or to multiple devices connected to multiple device resonators. Resonators may serve alternately or simultaneously as sources, devices, and/or they may be used to relay power from a source in one location to a device in another location. Intermediate electromagnetic resonators may be used to extend the distance range of wireless energy transfer systems and/or to generate areas of concentrated magnetic near-fields. Multiple resonators may be daisy-chained together, exchanging energy over extended distances and with a wide range of sources and devices. For example, a source resonator may transfer power to a device resonator via several repeater resonators. Energy from a source may be transferred to a first repeater resonator, the first repeater resonator may transfer the power to a second repeater resonator and the second to a third and so on until the final repeater resonator transfers its energy to a device resonator. In this respect the range or distance of wireless energy transfer may be extended and/or tailored by adding repeater resonators. High power levels may be split between multiple sources, transferred to multiple devices and recombined at a distant location.

The resonators may be designed using coupled mode theory models, circuit models, electromagnetic field models, and the like. The resonators may be designed to have tunable characteristic sizes. The resonators may be designed to handle different power levels. In exemplary embodiments, high power resonators may require larger conductors and higher current or voltage rated components than lower power resonators.

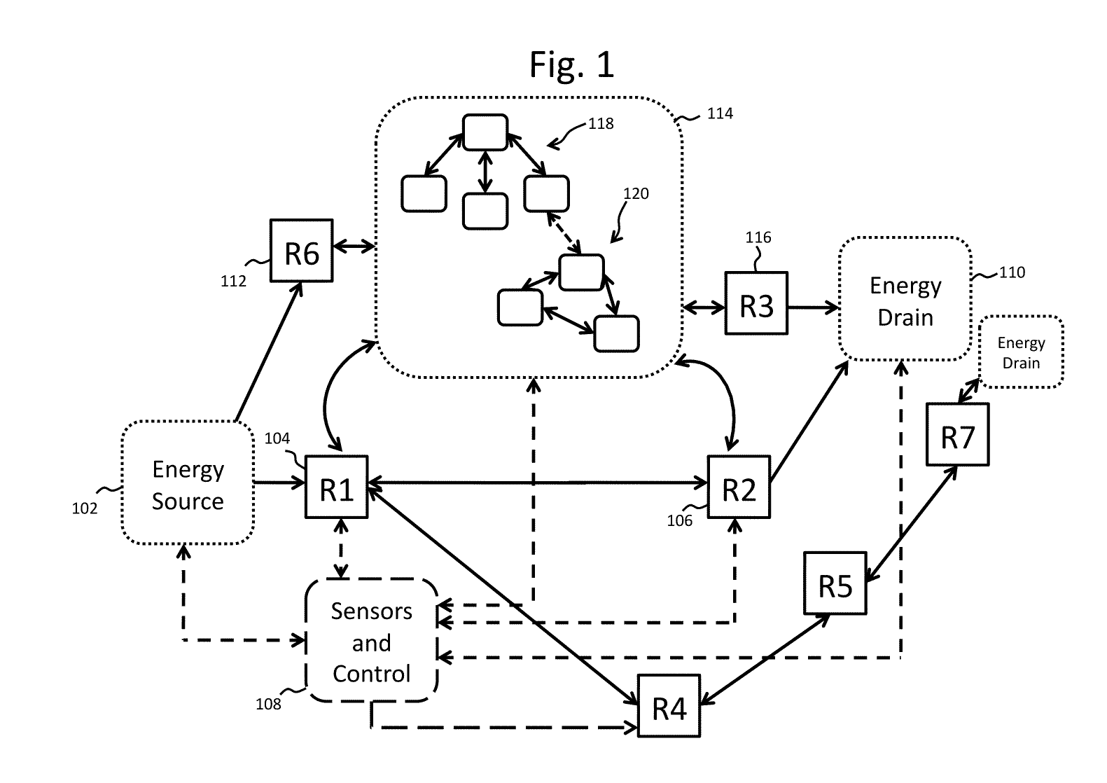

FIG. 1 shows a diagram of exemplary configurations and arrangements of a wireless energy transfer system. A wireless energy transfer system may include at least one source resonator (R1) 104 (optionally R6, 112) coupled to an energy source 102 and optionally a sensor and control unit 108. The energy source may be a source of any type of energy capable of being converted into electrical energy that may be used to drive the source resonator 104. The energy source may be a battery, a solar panel, the electrical mains, a wind or water turbine, an electromagnetic resonator, a generator, and the like. The electrical energy used to drive the magnetic resonator is converted into oscillating magnetic fields by the resonator. The oscillating magnetic fields may be captured by other resonators which may be device resonators (R2) 106, (R3) 116 that are optionally coupled to an energy drain 110. The oscillating fields may be optionally coupled to repeater resonators (R4, R5) that are configured to extend or tailor the wireless energy transfer region. Device resonators may capture the magnetic fields in the vicinity of source resonator(s), repeater resonators and other device resonators and convert them into electrical energy that may be used by an energy drain. The energy drain 110 may be an electrical, electronic, mechanical or chemical device and the like configured to receive electrical energy. Repeater resonators may capture magnetic fields in the vicinity of source, device and repeater resonator(s) and may pass the energy on to other resonators.

A wireless energy transfer system may comprise a single source resonator 104 coupled to an energy source 102 and a single device resonator 106 coupled to an energy drain 110. In embodiments a wireless energy transfer system may comprise multiple source resonators coupled to one or more energy sources and may comprise multiple device resonators coupled to one or more energy drains.

In embodiments the energy may be transferred directly between a source resonator 104 and a device resonator 106. In other embodiments the energy may be transferred from one or more source resonators 104, 112 to one or more device resonators 106, 116 via any number of intermediate resonators which may be device resonators, source resonators, repeater resonators, and the like. Energy may be transferred via a network or arrangement of resonators 114 that may include subnetworks 118, 120 arranged in any combination of topologies such as token ring, mesh, ad hoc, and the like.

In embodiments the wireless energy transfer system may comprise a centralized sensing and control system 108. In embodiments parameters of the resonators, energy sources, energy drains, network topologies, operating parameters, etc. may be monitored and adjusted from a control processor to meet specific operating parameters of the system. A central control processor may adjust parameters of individual components of the system to optimize global energy transfer efficiency, to optimize the amount of power transferred, and the like. Other embodiments may be designed to have a substantially distributed sensing and control system. Sensing and control may be incorporated into each resonator or group of resonators, energy sources, energy drains, and the like and may be configured to adjust the parameters of the individual components in the group to maximize or minimize the power delivered, to maximize energy transfer efficiency in that group and the like.

In embodiments, components of the wireless energy transfer system may have wireless or wired data communication links to other components such as devices, sources, repeaters, power sources, resonators, and the like and may transmit or receive data that can be used to enable the distributed or centralized sensing and control. A wireless communication channel may be separate from the wireless energy transfer channel, or it may be the same. In one embodiment the resonators used for power exchange may also be used to exchange information. In some cases, information may be exchanged by modulating a component in a source or device circuit and sensing that change with port parameter or other monitoring equipment. Resonators may signal each other by tuning, changing, varying, dithering, and the like, the resonator parameters such as the impedance of the resonators which may affect the reflected impedance of other resonators in the system. The systems and methods described herein may enable the simultaneous transmission of power and communication signals between resonators in wireless power transmission systems, or it may enable the transmission of power and communication signals during different time periods or at different frequencies using the same magnetic fields that are used during the wireless energy transfer. In other embodiments wireless communication may be enabled with a separate wireless communication channel such as WiFi, Bluetooth, Infrared, NFC, and the like.

In embodiments, a wireless energy transfer system may include multiple resonators and overall system performance may be improved by control of various elements in the system. For example, devices with lower power requirements may tune their resonant frequency away from the resonant frequency of a high-power source that supplies power to devices with higher power requirements. For another example, devices needing less power may adjust their rectifier circuits so that they draw less power from the source. In these ways, low and high power devices may safely operate or charge from a single high power source. In addition, multiple devices in a charging zone may find the power available to them regulated according to any of a variety of consumption control algorithms such as First-Come-First-Serve, Best Effort, Guaranteed Power, etc. The power consumption algorithms may be hierarchical in nature, giving priority to certain users or types of devices, or it may support any number of users by equally sharing the power that is available in the source. Power may be shared by any of the multiplexing techniques described in this disclosure.

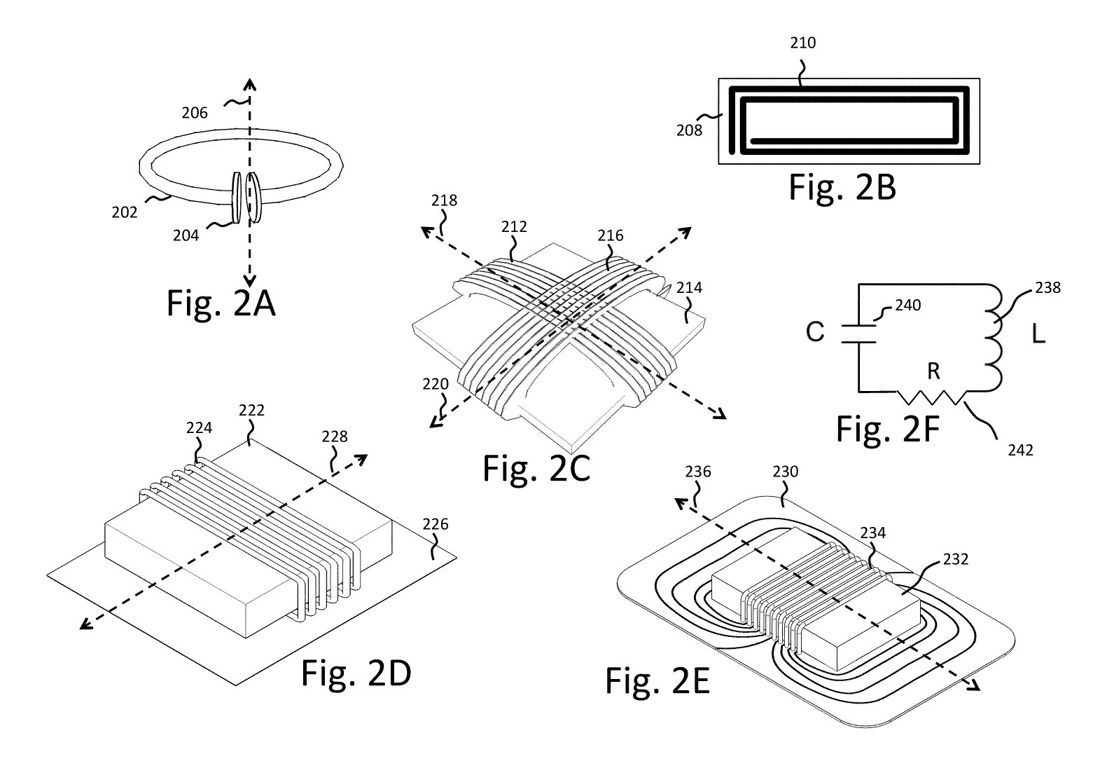

In embodiments electromagnetic resonators may be realized or implemented using a combination of shapes, structures, and configurations. Electromagnetic resonators may include an inductive element, a distributed inductance, or a combination of inductances with a total inductance, L, and a capacitive element, a distributed capacitance, or a combination of capacitances, with a total capacitance, C. A minimal circuit model of an electromagnetic resonator comprising capacitance, inductance and resistance, is shown in FIG. 2F. The resonator may include an inductive element 238 and a capacitive element 240. Provided with initial energy, such as electric field energy stored in the capacitor 240, the system will oscillate as the capacitor discharges transferring energy into magnetic field energy stored in the inductor 238 which in turn transfers energy back into electric field energy stored in the capacitor 240. Intrinsic losses in these electromagnetic resonators include losses due to resistance in the inductive and capacitive elements and to radiation losses, and are represented by the resistor, R, 242 in FIG. 2F.

FIG. 2A shows a simplified drawing of an exemplary magnetic resonator structure. The magnetic resonator may include a loop of conductor acting as an inductive element 202 and a capacitive element 204 at the ends of the conductor loop. The inductor 202 and capacitor 204 of an electromagnetic resonator may be bulk circuit elements, or the inductance and capacitance may be distributed and may result from the way the conductors are formed, shaped, or positioned, in the structure.

For example, the inductor 202 may be realized by shaping a conductor to enclose a surface area, as shown in FIGS. 2A. This type of resonator may be referred to as a capacitively-loaded loop inductor. Note that we may use the terms “loop” or “coil” to indicate generally a conducting structure (wire, tube, strip, etc.), enclosing a surface of any shape and dimension, with any number of turns. In FIG. 2A, the enclosed surface area is circular, but the surface may be any of a wide variety of other shapes and sizes and may be designed to achieve certain system performance specifications. In embodiments the inductance may be realized using inductor elements, distributed inductance, networks, arrays, series and parallel combinations of inductors and inductances, and the like. The inductance may be fixed or variable and may be used to vary impedance matching as well as resonant frequency operating conditions.

There are a variety of ways to realize the capacitance required to achieve the desired resonant frequency for a resonator structure. Capacitor plates 204 may be formed and utilized as shown in FIG. 2A, or the capacitance may be distributed and be realized between adjacent windings of a multi-loop conductor. The capacitance may be realized using capacitor elements, distributed capacitance, networks, arrays, series and parallel combinations of capacitances, and the like. The capacitance may be fixed or variable and may be used to vary impedance matching as well as resonant frequency operating conditions.

The inductive elements used in magnetic resonators may contain more than one loop and may spiral inward or outward or up or down or in some combination of directions. In general, the magnetic resonators may have a variety of shapes, sizes and number of turns and they may be composed of a variety of conducing materials. The conductor 210, for example, may be a wire, a Litz wire, a ribbon, a pipe, a trace formed from conducting ink, paint, gels, and the like or from single or multiple traces printed on a circuit board. An exemplary embodiment of a trace pattern on a substrate 208 forming inductive loops is depicted in FIG. 2B.

In embodiments the inductive elements may be formed using magnetic materials of any size, shape thickness, and the like, and of materials with a wide range of permeability and loss values. These magnetic materials may be solid blocks, they may enclose hollow volumes, they may be formed from many smaller pieces of magnetic material tiled and or stacked together, and they may be integrated with conducting sheets or enclosures made from highly conducting materials. Conductors may be wrapped around the magnetic materials to generate the magnetic field. These conductors may be wrapped around one or more than one axis of the structure. Multiple conductors may be wrapped around the magnetic materials and combined in parallel, or in series, or via a switch to form customized near-field patterns and/or to orient the dipole moment of the structure. Examples of resonators comprising magnetic material are depicted in FIGS. 2C, 2D, 2E. In FIG. 2D the resonator comprises loops of conductor 224 wrapped around a core of magnetic material 222 creating a structure that has a magnetic dipole moment 228 that is parallel to the axis of the loops of the conductor 224. The resonator may comprise multiple loops of conductor 216, 212 wrapped in orthogonal directions around the magnetic material 214 forming a resonator with a magnetic dipole moment 218, 220 that may be oriented in more than one direction as depicted in FIG. 2C, depending on how the conductors are driven.

An electromagnetic resonator may have a characteristic, natural, or resonant frequency determined by its physical properties. This resonant frequency is the frequency at which the energy stored by the resonator oscillates between that stored by the electric field, W_{E}, ( [symbol] , where q is the charge on the capacitor, C) and that stored by the magnetic field, W_{B}, ( [symbol] , where is the current through the inductor, L) of the resonator. The frequency at which this energy is exchanged may be called the characteristic frequency, the natural frequency, or the resonant frequency of the resonator, and is given by ω,

$$ω = 2 π f = \sqrt{\sqrt{\frac{1}{LC}}} .$$

The resonant frequency of the resonator may be changed by tuning the inductance, L, and/or the capacitance, C, of the resonator. In one embodiment system parameters are dynamically adjustable or tunable to achieve as close as possible to optimal operating conditions. However, based on the discussion above, efficient enough energy exchange may be realized even if some system parameters are not variable or components are not capable of dynamic adjustment.

In embodiments a resonator may comprise an inductive element coupled to more than one capacitor arranged in a network of capacitors and circuit elements. In embodiments the coupled network of capacitors and circuit elements may be used to define more than one resonant frequency of the resonator. In embodiments a resonator may be resonant, or partially resonant, at more than one frequency.

In embodiments, a wireless power source may comprise of at least one resonator coil coupled to a power supply, which may be a switching amplifier, such as a class-D amplifier or a class-E amplifier or a combination thereof. In this case, the resonator coil is effectively a power load to the power supply. In embodiments, a wireless power device may comprise of at least one resonator coil coupled to a power load, which may be a switching rectifier, such as a class-D rectifier or a class-E rectifier or a combination thereof. In this case, the resonator coil is effectively a power supply for the power load, and the impedance of the load directly relates also to the work-drainage rate of the load from the resonator coil. The efficiency of power transmission between a power supply and a power load may be impacted by how closely matched the output impedance of the power source is to the input impedance of the load. Power may be delivered to the load at a maximum possible efficiency, when the input impedance of the load is equal to the complex conjugate of the internal impedance of the power supply. Designing the power supply or power load impedance to obtain a maximum power transmission efficiency is often called “impedance matching”, and may also referred to as optimizing the ratio of useful-to-lost powers in the system. Impedance matching may be performed by adding networks or sets of elements such as capacitors, inductors, transformers, switches, resistors, and the like, to form impedance matching networks between a power supply and a power load. In embodiments, mechanical adjustments and changes in element positioning may be used to achieve impedance matching. For varying loads, the impedance matching network may include variable components that are dynamically adjusted to ensure that the impedance at the power supply terminals looking towards the load and the characteristic impedance of the power supply remain substantially complex conjugates of each other, even in dynamic environments and operating scenarios.

In embodiments, impedance matching may be accomplished by tuning the duty cycle, and/or the phase, and/or the frequency of the driving signal of the power supply or by tuning a physical component within the power supply, such as a capacitor. Such a tuning mechanism may be advantageous because it may allow impedance matching between a power supply and a load without the use of a tunable impedance matching network, or with a simplified tunable impedance matching network, such as one that has fewer tunable components for example. In embodiments, tuning the duty cycle, and/or frequency, and/or phase of the driving signal to a power supply may yield a dynamic impedance matching system with an extended tuning range or precision, with higher power, voltage and/or current capabilities, with faster electronic control, with fewer external components, and the like.

In some wireless energy transfer systems the parameters of the resonator such as the inductance may be affected by environmental conditions such as surrounding objects, temperature, orientation, number and position of other resonators and the like. Changes in operating parameters of the resonators may change certain system parameters, such as the efficiency of transferred power in the wireless energy transfer. For example, high-conductivity materials located near a resonator may shift the resonant frequency of a resonator and detune it from other resonant objects. In some embodiments, a resonator feedback mechanism is employed that corrects its frequency by changing a reactive element (e.g., an inductive element or capacitive element). In order to achieve acceptable matching conditions, at least some of the system parameters may need to be dynamically adjustable or tunable. All the system parameters may be dynamically adjustable or tunable to achieve approximately the optimal operating conditions. However, efficient enough energy exchange may be realized even if all or some system parameters are not variable. In some examples, at least some of the devices may not be dynamically adjusted. In some examples, at least some of the sources may not be dynamically adjusted. In some examples, at least some of the intermediate resonators may not be dynamically adjusted. In some examples, none of the system parameters may be dynamically adjusted.

In some embodiments changes in parameters of components may be mitigated by selecting components with characteristics that change in a complimentary or opposite way or direction when subjected to differences in operating environment or operating point. In embodiments, a system may be designed with components, such as capacitors, that have an opposite dependence or parameter fluctuation due to temperature, power levels, frequency, and the like. In some embodiments, the component values as a function of temperature may be stored in a look-up table in a system microcontroller and the reading from a temperature sensor may be used in the system control feedback loop to adjust other parameters to compensate for the temperature induced component value changes.

In some embodiments the changes in parameter values of components may be compensated with active tuning circuits comprising tunable components. Circuits that monitor the operating environment and operating point of components and system may be integrated in the design. The monitoring circuits may provide the signals necessary to actively compensate for changes in parameters of components. For example, a temperature reading may be used to calculate expected changes in, or to indicate previously measured values of, capacitance of the system allowing compensation by switching in other capacitors or tuning capacitors to maintain the desired capacitance over a range of temperatures. In embodiments, the RF amplifier switching waveforms may be adjusted to compensate for component value or load changes in the system. In some embodiments the changes in parameters of components may be compensated with active cooling, heating, active environment conditioning, and the like.

The parameter measurement circuitry may measure or monitor certain power, voltage, and current, signals in the system, and processors or control circuits may adjust certain settings or operating parameters based on those measurements. In addition the magnitude and phase of voltage and current signals, and the magnitude of the power signals, throughout the system may be accessed to measure or monitor the system performance. The measured signals referred to throughout this disclosure may be any combination of port parameter signals, as well as voltage signals, current signals, power signals, temperatures signals and the like. These parameters may be measured using analog or digital techniques, they may be sampled and processed, and they may be digitized or converted using a number of known analog and digital processing techniques. In embodiments, preset values of certain measured quantities are loaded in a system controller or memory location and used in various feedback and control loops. In embodiments, any combination of measured, monitored, and/or preset signals may be used in feedback circuits or systems to control the operation of the resonators and/or the system.

Adjustment algorithms may be used to adjust the frequency, Q, and/or impedance of the magnetic resonators. The algorithms may take as inputs reference signals related to the degree of deviation from a desired operating point for the system and may output correction or control signals related to that deviation that control variable or tunable elements of the system to bring the system back towards the desired operating point or points. The reference signals for the magnetic resonators may be acquired while the resonators are exchanging power in a wireless power transmission system, or they may be switched out of the circuit during system operation. Corrections to the system may be applied or performed continuously, periodically, upon a threshold crossing, digitally, using analog methods, and the like.

In embodiments, lossy extraneous materials and objects may introduce potential reductions in efficiencies by absorbing the magnetic and/or electric energy of the resonators of the wireless power transmission system. Those impacts may be mitigated in various embodiments by positioning resonators to minimize the effects of the lossy extraneous materials and objects and by placing structural field shaping elements (e.g., conductive structures, plates and sheets, magnetic material structures, plates and sheets, and combinations thereof) to minimize their effect.

One way to reduce the impact of lossy materials on a resonator is to use high-conductivity materials, magnetic materials, or combinations thereof to shape the resonator fields such that they avoid the lossy objects. In an exemplary embodiment, a layered structure of high-conductivity material and magnetic material may tailor, shape, direct, reorient, etc. the resonator's electromagnetic fields so that they avoid lossy objects in their vicinity by deflecting the fields. FIG. 2D shows a top view of a resonator with a sheet of conductor 226 below the magnetic material that may be used to tailor the fields of the resonator so that they avoid lossy objects that may be below the sheet of conductor 226. The layer or sheet of good conductor 226 may comprise any high conductivity materials such as copper, silver, aluminum, as may be most appropriate for a given application. In certain embodiments, the layer or sheet of good conductor is thicker than the skin depth of the conductor at the resonator operating frequency. The conductor sheet may be preferably larger than the size of the resonator, extending beyond the physical extent of the resonator.

In environments and systems where the amount of power being transmitted could present a safety hazard to a person or animal that may intrude into the active field volume, safety measures may be included in the system. In embodiments where power levels require particularized safety measures, the packaging, structure, materials, and the like of the resonators may be designed to provide a spacing or “keep away” zone from the conducting loops in the magnetic resonator. To provide further protection, high-Q resonators and power and control circuitry may be located in enclosures that confine high voltages or currents to within the enclosure, that protect the resonators and electrical components from weather, moisture, sand, dust, and other external elements, as well as from impacts, vibrations, scrapes, explosions, and other types of mechanical shock. Such enclosures call for attention to various factors such as thermal dissipation to maintain an acceptable operating temperature range for the electrical components and the resonator. In embodiments, enclosure may be constructed of non-lossy materials such as composites, plastics, wood, concrete, and the like and may be used to provide a minimum distance from lossy objects to the resonator components. A minimum separation distance from lossy objects or environments which may include metal objects, salt water, oil and the like, may improve the efficiency of wireless energy transfer. In embodiments, a “keep away” zone may be used to increase the perturbed Q of a resonator or system of resonators. In embodiments a minimum separation distance may provide for a more reliable or more constant operating parameters of the resonators.

In embodiments, resonators and their respective sensor and control circuitry may have various levels of integration with other electronic and control systems and subsystems. In some embodiments the power and control circuitry and the device resonators are completely separate modules or enclosures with minimal integration to existing systems, providing a power output and a control and diagnostics interface. In some embodiments a device is configured to house a resonator and circuit assembly in a cavity inside the enclosure, or integrated into the housing or enclosure of the device.

Example Resonator Circuitry

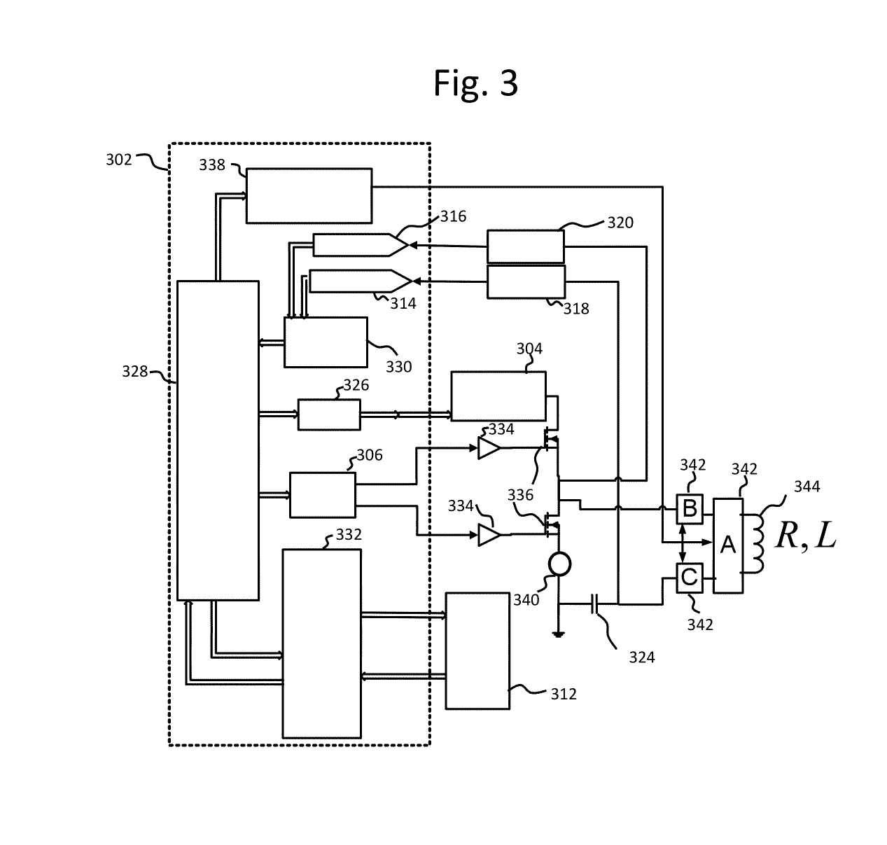

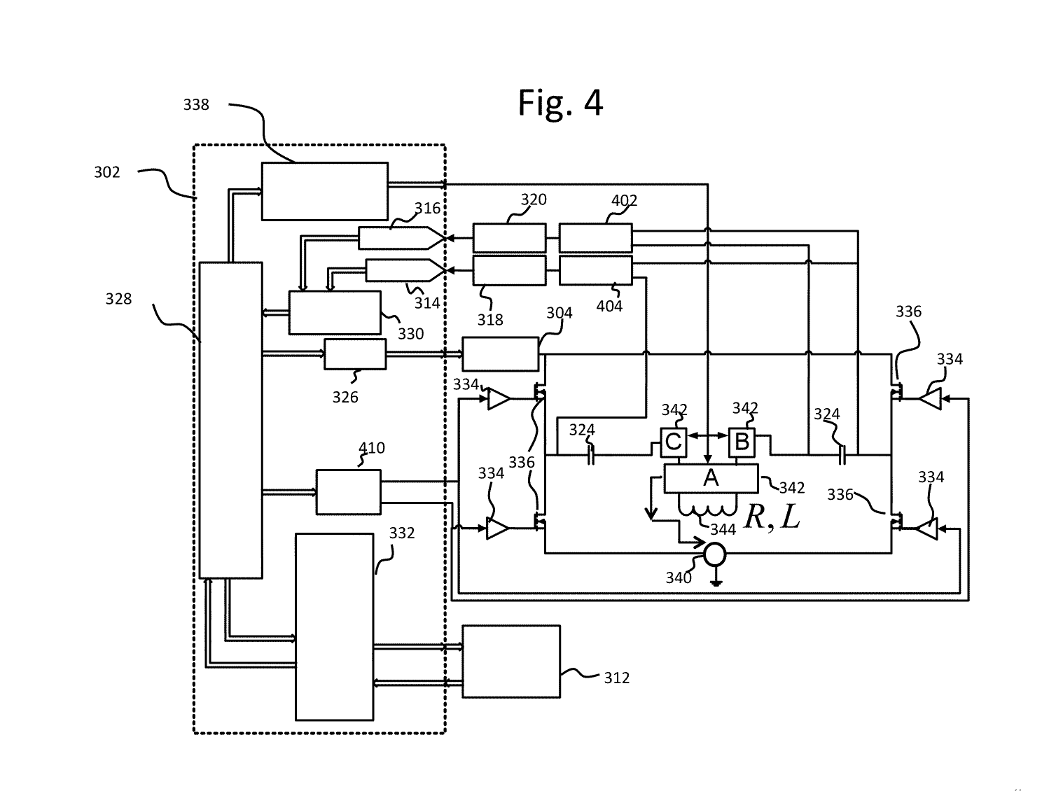

FIGS. 3 and 4 show high level block diagrams depicting power generation, monitoring, and control components for exemplary sources of a wireless energy transfer system.

FIG. 3 is a block diagram of a source comprising a half-bridge switching power amplifier and some of the associated measurement, tuning, and control circuitry. FIG. 4 is a block diagram of a source comprising a full-bridge switching amplifier and some of the associated measurement, tuning, and control circuitry.

The half bridge system topology depicted in FIG. 3 may comprise a processing unit that executes a control algorithm 328. The processing unit executing a control algorithm 328 may be a microcontroller, an application specific circuit, a field programmable gate array, a processor, a digital signal processor, and the like. The processing unit may be a single device or it may be a network of devices. The control algorithm may run on any portion of the processing unit. The algorithm may be customized for certain applications and may comprise a combination of analog and digital circuits and signals. The master algorithm may measure and adjust voltage signals and levels, current signals and levels, signal phases, digital count settings, and the like.

The system may comprise an optional source/device and/or source/other resonator communication controller 332 coupled to wireless communication circuitry 312. The optional source/device and/or source/other resonator communication controller 332 may be part of the same processing unit that executes the master control algorithm, it may a part or a circuit within a microcontroller 302, it may be external to the wireless power transmission modules, it may be substantially similar to communication controllers used in wire powered or battery powered applications but adapted to include some new or different functionality to enhance or support wireless power transmission.

The system may comprise a PWM generator 306 coupled to at least two transistor gate drivers 334 and may be controlled by the control algorithm. The two transistor gate drivers 334 may be coupled directly or via gate drive transformers to two power transistors 336 that drive the source resonator coil 344 through impedance matching network components 342. The power transistors 336 may be coupled and powered with an adjustable DC supply 304 and the adjustable DC supply 304 may be controlled by a variable bus voltage, Vbus. The Vbus controller may be controlled by the control algorithm 328 and may be part of, or integrated into, a microcontroller 302 or other integrated circuits. The Vbus controller 326 may control the voltage output of an adjustable DC supply 304 which may be used to control power output of the amplifier and power delivered to the resonator coil 344.

The system may comprise sensing and measurement circuitry including signal filtering and buffering circuits 318, 320 that may shape, modify, filter, process, buffer, and the like, signals prior to their input to processors and/or converters such as analog to digital converters (ADC) 314, 316, for example. The processors and converters such as ADCs 314, 316 may be integrated into a microcontroller 302 or may be separate circuits that may be coupled to a processing core 330. Based on measured signals, the control algorithm 328 may generate, limit, initiate, extinguish, control, adjust, or modify the operation of any of the PWM generator 306, the communication controller 332, the Vbus control 326, the source impedance matching controller 338, the filter/buffering elements, 318, 320, the converters, 314, 316, the resonator coil 344, and may be part of, or integrated into, a microcontroller 302 or a separate circuit. The impedance matching networks 342 and resonator coils 344 may include electrically controllable, variable, or tunable components such as capacitors, switches, inductors, and the like, as described herein, and these components may have their component values or operating points adjusted according to signals received from the source impedance matching controller 338. Components may be tuned to adjust the operation and characteristics of the resonator including the power delivered to and by the resonator, the resonant frequency of the resonator, the impedance of the resonator, the Q of the resonator, and any other coupled systems, and the like. The resonator may be any type or structure resonator described herein including a capacitively loaded loop resonator, a planer resonator comprising a magnetic material or any combination thereof.

The full bridge system topology depicted in FIG. 4 may comprise a processing unit that executes a master control algorithm 328. The processing unit executing the control algorithm 328 may be a microcontroller, an application specific circuit, a field programmable gate array, a processor, a digital signal processor, and the like. The system may comprise a source/device and/or source/other resonator communication controller 332 coupled to wireless communication circuitry 312. The source/device and/or source/other resonator communication controller 332 may be part of the same processing unit that executes that master control algorithm, it may a part or a circuit within a microcontroller 302, it may be external to the wireless power transmission modules, it may be substantially similar to communication controllers used in wire powered or battery powered applications but adapted to include some new or different functionality to enhance or support wireless power transmission.

The system may comprise a PWM generator 410 with at least two outputs coupled to at least four transistor gate drivers 334 that may be controlled by signals generated in a master control algorithm. The four transistor gate drivers 334 may be coupled to four power transistors 336 directly or via gate drive transformers that may drive the source resonator coil 344 through impedance matching networks 342. The power transistors 336 may be coupled and powered with an adjustable DC supply 304 and the adjustable DC supply 304 may be controlled by a Vbus controller 326 which may be controlled by a master control algorithm. The Vbus controller 326 may control the voltage output of the adjustable DC supply 304 which may be used to control power output of the amplifier and power delivered to the resonator coil 344.

The system may comprise sensing and measurement circuitry including signal filtering and buffering circuits 318, 320 and differential/single ended conversion circuitry 402, 404 that may shape, modify, filter, process, buffer, and the like, signals prior to being input to processors and/or converters such as analog to digital converters (ADC) 314, 316. The processors and/or converters such as ADC 314, 316 may be integrated into a microcontroller 302 or may be separate circuits that may be coupled to a processing core 330. Based on measured signals, the master control algorithm may generate, limit, initiate, extinguish, control, adjust, or modify the operation of any of the PWM generator 410, the communication controller 332, the Vbus controller 326, the source impedance matching controller 338, the filter/buffering elements, 318, 320, differential/single ended conversion circuitry 402, 404, the converters, 314, 316, the resonator coil 344, and may be part of or integrated into a microcontroller 302 or a separate circuit.

Impedance matching networks 342 and resonator coils 344 may comprise electrically controllable, variable, or tunable components such as capacitors, switches, inductors, and the like, as described herein, and these components may have their component values or operating points adjusted according to signals received from the source impedance matching controller 338. Components may be tuned to enable tuning of the operation and characteristics of the resonator including the power delivered to and by the resonator, the resonant frequency of the resonator, the impedance of the resonator, the Q of the resonator, and any other coupled systems, and the like. The resonator may be any type or structure resonator described herein including a capacitively loaded loop resonator, a planar resonator comprising a magnetic material or any combination thereof.

Impedance matching networks may comprise fixed value components such as capacitors, inductors, and networks of components as described herein. Parts of the impedance matching networks, A, B and C, may comprise inductors, capacitors, transformers, and series and parallel combinations of such components, as described herein. In some embodiments, parts of the impedance matching networks A, B, and C, may be empty (short-circuited). In some embodiments, part B comprises a series combination of an inductor and a capacitor, and part C is empty.

The full bridge topology may allow operation at higher output power levels using the same DC bus voltage as an equivalent half bridge amplifier. The half bridge exemplary topology of FIG. 3 may provide a single-ended drive signal, while the exemplary full bridge topology of FIG. 4 may provide a differential drive to the source resonator 308. The impedance matching topologies and components and the resonator structure may be different for the two systems, as discussed herein.

The exemplary systems depicted in FIGS. 3 and 4 may further include fault detection circuitry 340 that may be used to trigger the shutdown of the microcontroller in the source amplifier or to change or interrupt the operation of the amplifier. This protection circuitry may comprise a high speed comparator or comparators to monitor the amplifier return current, the amplifier bus voltage (Vbus) from the DC supply 304, the voltage across the source resonator 308 and/or the optional tuning board, or any other voltage or current signals that may cause damage to components in the system or may yield undesirable operating conditions. Preferred embodiments may depend on the potentially undesirable operating modes associated with different applications. In some embodiments, protection circuitry may not be implemented or circuits may not be populated. In some embodiments, system and component protection may be implemented as part of a master control algorithm and other system monitoring and control circuits. In embodiments, dedicated fault circuitry 340 may include an output (not shown) coupled to a master control algorithm 328 that may trigger a system shutdown, a reduction of the output power (e.g. reduction of Vbus), a change to the PWM generator, a change in the operating frequency, a change to a tuning element, or any other reasonable action that may be implemented by the control algorithm 328 to adjust the operating point mode, improve system performance, and/or provide protection.

As described herein, sources in wireless power transfer systems may use a measurement of the input impedance of the impedance matching network 342 driving source resonator coil 344 as an error or control signal for a system control loop that may be part of the master control algorithm. In exemplary embodiments, variations in any combination of three parameters may be used to tune the wireless power source to compensate for changes in environmental conditions, for changes in coupling, for changes in device power demand, for changes in module, circuit, component or subsystem performance, for an increase or decrease in the number or sources, devices, or repeaters in the system, for user initiated changes, and the like. In exemplary embodiments, changes to the amplifier duty cycle, to the component values of the variable electrical components such as variable capacitors and inductors, and to the DC bus voltage may be used to change the operating point or operating range of the wireless source and improve some system operating value. The specifics of the control algorithms employed for different applications may vary depending on the desired system performance and behavior.

Impedance measurement circuitry such as described herein, and shown in FIGS. 3 and 4, may be implemented using two-channel simultaneous sampling ADCs and these ADCs may be integrated into a microcontroller chip or may be part of a separate circuit. Simultaneously sampling of the voltage and current signals at the input to a source resonator's impedance matching network and/or the source resonator may yield the phase and magnitude information of the current and voltage signals and may be processed using known signal processing techniques to yield complex impedance parameters. In some embodiments, monitoring only the voltage signals or only the current signals may be sufficient.

The impedance measurements described herein may use direct sampling methods which may be relatively simpler than some other known sampling methods. In embodiments, measured voltage and current signals may be conditioned, filtered and scaled by filtering/buffering circuitry before being input to ADCs. In embodiments, the filter/buffering circuitry may be adjustable to work at a variety of signal levels and frequencies, and circuit parameters such as filter shapes and widths may be adjusted manually, electronically, automatically, in response to a control signal, by the master control algorithm, and the like. Exemplary embodiments of filter/buffering circuits are shown in FIGS. 3, 4, and 5.

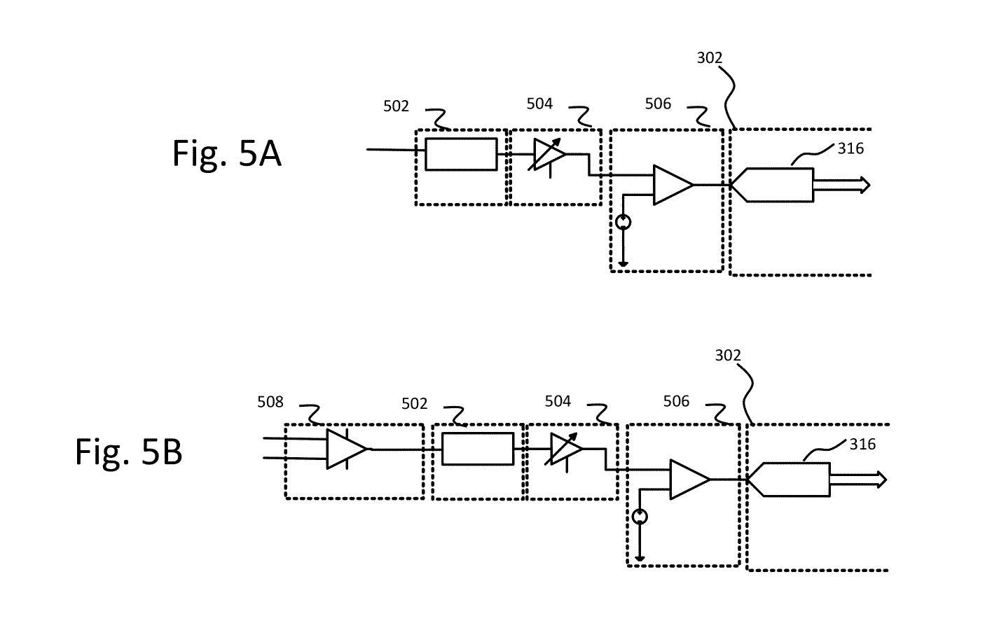

FIG. 5 shows more detailed views of exemplary circuit components that may be used in filter/buffering circuitry. In embodiments, and depending on the types of ADCs used in the system designs, single-ended amplifier topologies may reduce the complexity of the analog signal measurement paths used to characterize system, subsystem, module, and/or component performance by eliminating the need for hardware to convert from differential to single-ended signal formats. In other implementations, differential signal formats may be preferable. The implementations shown in FIG. 5 are exemplary, and should not be construed to be the only possible way to implement the functionality described herein. Rather it should be understood that the analog signal path may employ components with different input requirements and hence may have different signal path architectures.

In both the single ended and differential amplifier topologies, the input current to the impedance matching networks 342 driving the resonator coils 344 may be obtained by measuring the voltage across a capacitor 324, or via a current sensor of some type. For the exemplary single-ended amplifier topology in FIG. 3, the current may be sensed on the ground return path from the impedance matching network 342. For the exemplary differential power amplifier depicted in FIG. 4, the input current to the impedance matching networks 342 driving the resonator coils 344 may be measured using a differential amplifier across the terminals of a capacitor 324 or via a current sensor of some type. In the differential topology of FIG. 4, the capacitor 324 may be duplicated at the negative output terminal of the source power amplifier.

In both topologies, after single ended signals representing the input voltage and current to the source resonator and impedance matching network are obtained, the signals may be filtered 502 to obtain the desired portions of the signal waveforms. In embodiments, the signals may be filtered to obtain the fundamental component of the signals. In embodiments, the type of filtering performed, such as low pass, bandpass, notch, and the like, as well as the filter topology used, such as elliptical, Chebyshev, Butterworth, and the like, may depend on the specific requirements of the system. In some embodiments, no filtering will be required.

The voltage and current signals may be amplified by an optional amplifier 504. The gain of the optional amplifier 504 may be fixed or variable. The gain of the amplifier may be controlled manually, electronically, automatically, in response to a control signal, and the like. The gain of the amplifier may be adjusted in a feedback loop, in response to a control algorithm, by the master control algorithm, and the like. In embodiments, required performance specifications for the amplifier may depend on signal strength and desired measurement accuracy, and may be different for different application scenarios and control algorithms.

The measured analog signals may have a DC offset added to them, 506, which may be required to bring the signals into the input voltage range of the ADC which for some systems may be 0 to 3.3V. In some systems this stage may not be required, depending on the specifications of the particular ADC used.

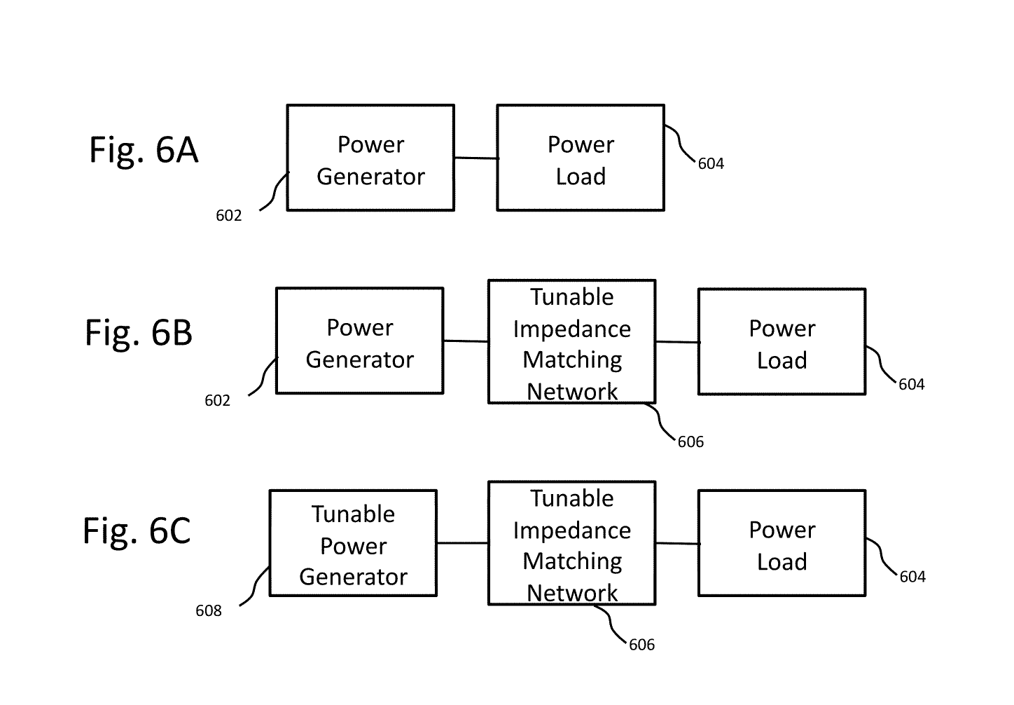

As described above, the efficiency of power transmission between a power generator and a power load may be impacted by how closely matched the output impedance of the generator is to the input impedance of the load. In an exemplary system as shown in FIG. 6A, power may be delivered to the load at a maximum possible efficiency, when the input impedance of the load 604 is equal to the complex conjugate of the internal impedance of the power generator or the power amplifier 602. Designing the generator or load impedance to obtain a high and/or maximum power transmission efficiency may be called “impedance matching”. Impedance matching may be performed by inserting appropriate networks or sets of elements such as capacitors, resistors, inductors, transformers, switches and the like, to form an impedance matching network 606, between a power generator 602 and a power load 604 as shown in FIG. 6B. In other embodiments, mechanical adjustments and changes in element positioning may be used to achieve impedance matching. As described above for varying loads, the impedance matching network 606 may include variable components that are dynamically adjusted to ensure that the impedance at the generator terminals looking towards the load and the characteristic impedance of the generator remain substantially complex conjugates of each other, even in dynamic environments and operating scenarios. In embodiments, dynamic impedance matching may be accomplished by tuning the duty cycle, and/or the phase, and/or the frequency of the driving signal of the power generator or by tuning a physical component within the power generator, such as a capacitor, as depicted in FIG. 6C. Such a tuning mechanism may be advantageous because it may allow impedance matching between a power generator 608 and a load without the use of a tunable impedance matching network, or with a simplified tunable impedance matching network 606, such as one that has fewer tunable components for example. In embodiments, tuning the duty cycle, and/or frequency, and/or phase of the driving signal to a power generator may yield a dynamic impedance matching system with an extended tuning range or precision, with higher power, voltage and/or current capabilities, with faster electronic control, with fewer external components, and the like. The impedance matching methods, architectures, algorithms, protocols, circuits, measurements, controls, and the like, described below, may be useful in systems where power generators drive high-Q magnetic resonators and in high-Q wireless power transmission systems as described herein. In wireless power transfer systems a power generator may be a power amplifier driving a resonator, sometimes referred to as a source resonator, which may be a load to the power amplifier. In wireless power applications, it may be preferable to control the impedance matching between a power amplifier and a resonator load to control the efficiency of the power delivery from the power amplifier to the resonator. The impedance matching may be accomplished, or accomplished in part, by tuning or adjusting the duty cycle, and/or the phase, and/or the frequency of the driving signal of the power amplifier that drives the resonator.

Wireless Power Repeater Resonators

A wireless power transfer system may incorporate a repeater resonator configured to exchange energy with one or more source resonators, device resonators, or additional repeater resonators. A repeater resonator may be used to extend the range of wireless power transfer. A repeater resonator may be used to change, distribute, concentrate, enhance, and the like, the magnetic field generated by a source. A repeater resonator may be used to guide magnetic fields of a source resonator around lossy and/or metallic objects that might otherwise block the magnetic field. A repeater resonator may be used to eliminate or reduce areas of low power transfer, or areas of low magnetic field around a source. A repeater resonator may be used to improve the coupling efficiency between a source and a target device resonator or resonators, and may be used to improve the coupling between resonators with different orientations, or whose dipole moments are not favorably aligned.

An oscillating magnetic field produced by a source magnetic resonator can cause electrical currents in the conductor part of the repeater resonator. These electrical currents may create their own magnetic field as they oscillate in the resonator thereby extending or changing the magnetic field area or the magnetic field distribution of the source.

In embodiments, a repeater resonator may operate as a source for one or more device resonators. In other embodiments, a device resonator may simultaneously receive a magnetic field and repeat a magnetic field. In still other embodiments, a resonator may alternate between operating as a source resonator, device resonator or repeater resonator. The alternation may be achieved through time multiplexing, frequency multiplexing, self-tuning, or through a centralized control algorithm. In embodiments, multiple repeater resonators may be positioned in an area and tuned in and out of resonance to achieve a spatially varying magnetic field. In embodiments, a local area of strong magnetic field may be created by an array of resonators, and the positioned of the strong field area may be moved around by changing electrical components or operating characteristics of the resonators in the array.

In embodiments a repeater resonator may be a capacitively loaded loop magnetic resonator. In embodiments a repeater resonator may be a capacitively loaded loop magnetic resonator wrapper around magnetic material. In embodiments the repeater resonator may be tuned to have a resonant frequency that is substantially equal to that of the frequency of a source or device or at least one other repeater resonator with which the repeater resonator is designed to interact or couple. In other embodiments the repeater resonator may be detuned to have a resonant frequency that is substantially greater than, or substantially less than the frequency of a source or device or at least one other repeater resonator with which the repeater resonator is designed to interact or couple. Preferably, the repeater resonator may be a high-Q magnetic resonator with an intrinsic quality factor, Qᵣ, of 100 or more. In some embodiments the repeater resonator may have quality factor of less than 100. In some embodiments,

$$\sqrt{\sqrt{{Q}_{s} {Q}_{r}}} > 100.$$

In other embodiments,

$$\sqrt{\sqrt{{Q}_{d} {Q}_{r}}} > 100.$$

In still other embodiments,

$$\sqrt{\sqrt{{Q}_{r 1} {Q}_{r 2}}} > 100.$$

In embodiments, the repeater resonator may include only the inductive and capacitive components that comprise the resonator without any additional circuitry, for connecting to sources, loads, controllers, monitors, control circuitry and the like. In some embodiments the repeater resonator may include additional control circuitry, tuning circuitry, measurement circuitry, or monitoring circuitry. Additional circuitry may be used to monitor the voltages, currents, phase, inductance, capacitance, and the like of the repeater resonator. The measured parameters of the repeater resonator may be used to adjust or tune the repeater resonator. A controller or a microcontroller may be used by the repeater resonator to actively adjust the capacitance, resonant frequency, inductance, resistance, and the like of the repeater resonator. A tunable repeater resonator may be necessary to prevent the repeater resonator from exceeding its voltage, current, temperature, or power limits. A repeater resonator may for example detune its resonant frequency to reduce the amount of power transferred to the repeater resonator, or to modulate or control how much power is transferred to other devices or resonators that couple to the repeater resonator.

In some embodiments the power and control circuitry of the repeater resonators may be powered by the energy captured by the repeater resonator. The repeater resonator may include AC to DC, AC to AC, or DC to DC converters and regulators to provide power to the control or monitoring circuitry. In some embodiments the repeater resonator may include an additional energy storage component such as a battery or a super capacitor to supply power to the power and control circuitry during momentary or extended periods of wireless power transfer interruptions. The battery, super capacitor, or other power storage component may be periodically or continuously recharged during normal operation when the repeater resonator is within range of any wireless power source.

In some embodiments the repeater resonator may include communication or signaling capability such as WiFi, Bluetooth, near field, and the like that may be used to coordinate power transfer from a source or multiple sources to a specific location or device or to multiple locations or devices. Repeater resonators spread across a location may be signaled to selectively tune or detune from a specific resonant frequency to extend the magnetic field from a source to a specific location, area, or device. Multiple repeater resonators may be used to selectively tune, or detune, or relay power from a source to specific areas or devices.

The repeater resonators may include a device into which some, most, or all of the energy transferred or captured from the source to the repeater resonator may be available for use. The repeater resonator may provide power to one or more electric or electronic devices while relaying or extending the range of the source. In some embodiments low power consumption devices such as lights, LEDs, displays, sensors, and the like may be part of the repeater resonator.

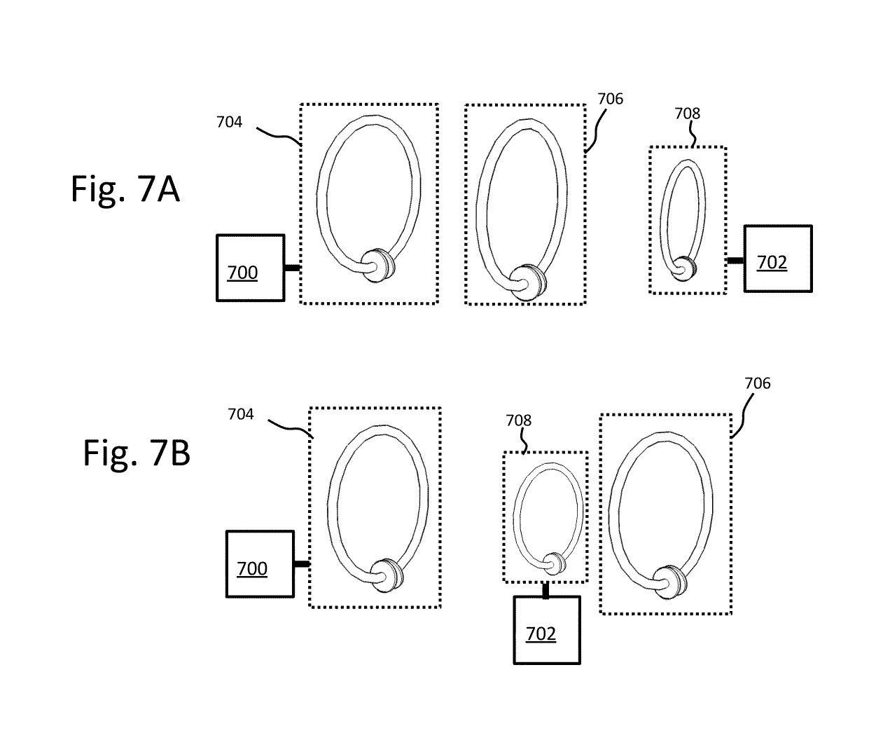

Several possible usage configurations are shown in FIGS. 7-9 showing example arrangements of a wireless power transfer system that includes a source resonator 704 coupled to a power source 700, a device resonator 708 coupled to a device 702, and a repeater resonator 706. In some embodiments, a repeater resonator may be used between the source and the device resonator to extend the range of the source. In some embodiments the repeater resonator may be positioned after, and further away from the source than the device resonator as shown in FIG. 7B. For the configuration shown in FIG. 7B more efficient power transfer between the source and the device may be possible compared to if no repeater resonator was used. In embodiments of the configuration shown in FIG. 7B it may be preferable for the repeater resonator to be larger than the device resonator.

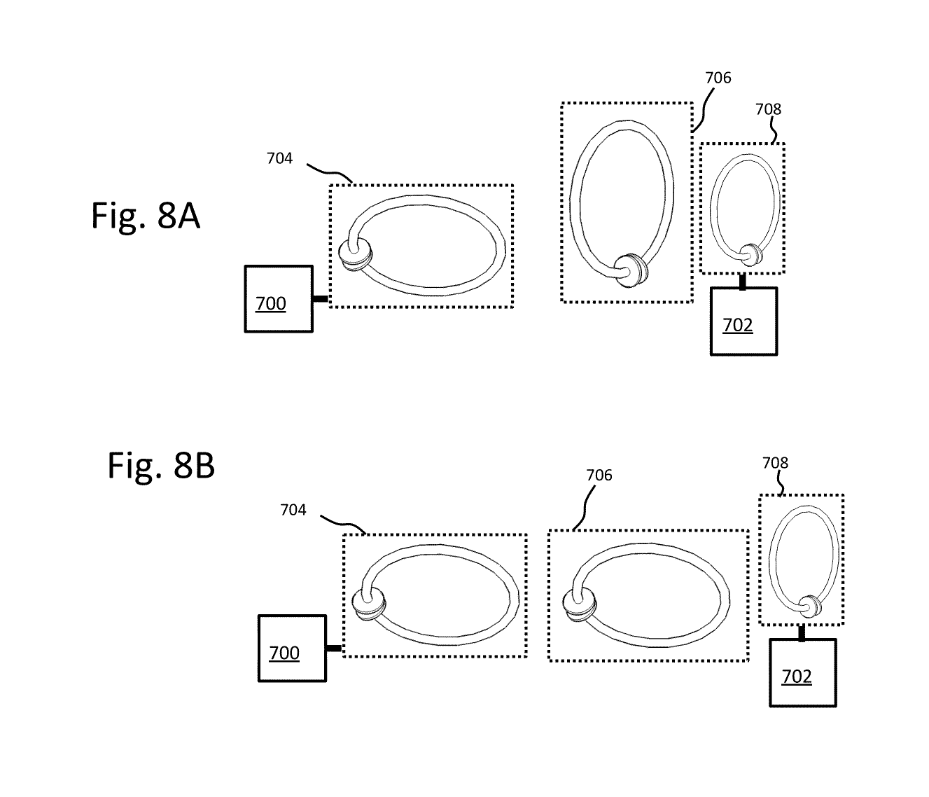

In some embodiments a repeater resonator may be used to improve coupling between non-coaxial resonators or resonators whose dipole moments are not aligned for high coupling factors or energy transfer efficiencies. For example, a repeater resonator may be used to enhance coupling between a source and a device resonator that are not coaxially aligned by placing the repeater resonator between the source and device aligning it with the device resonator as shown in FIG. 8A or aligning with the source resonator as shown in FIG. 8B.

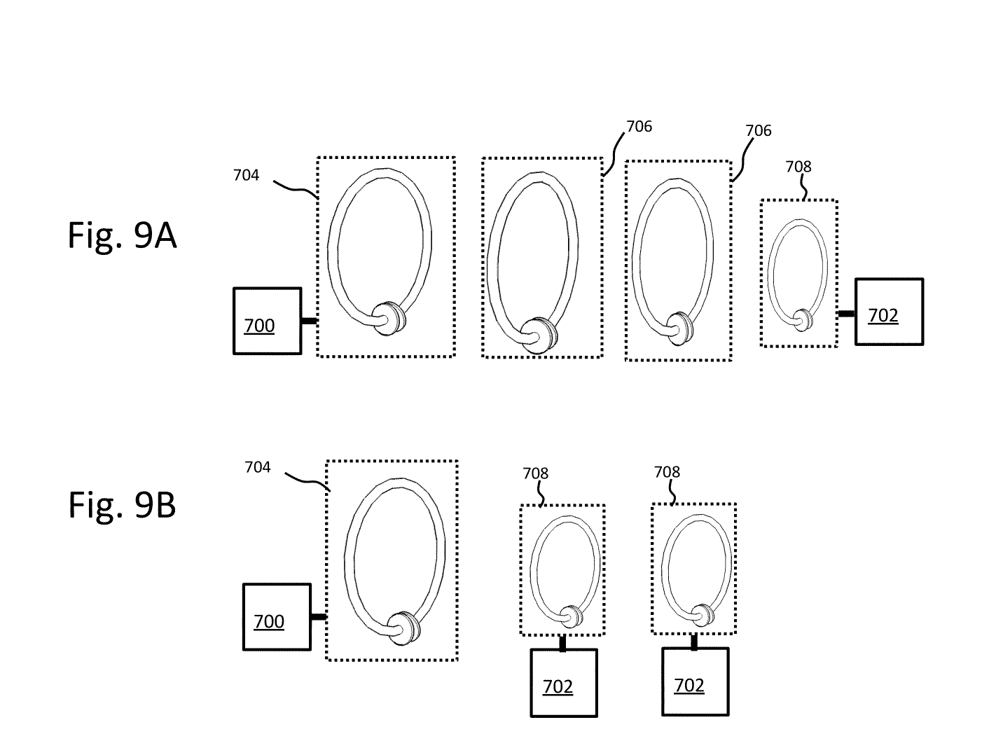

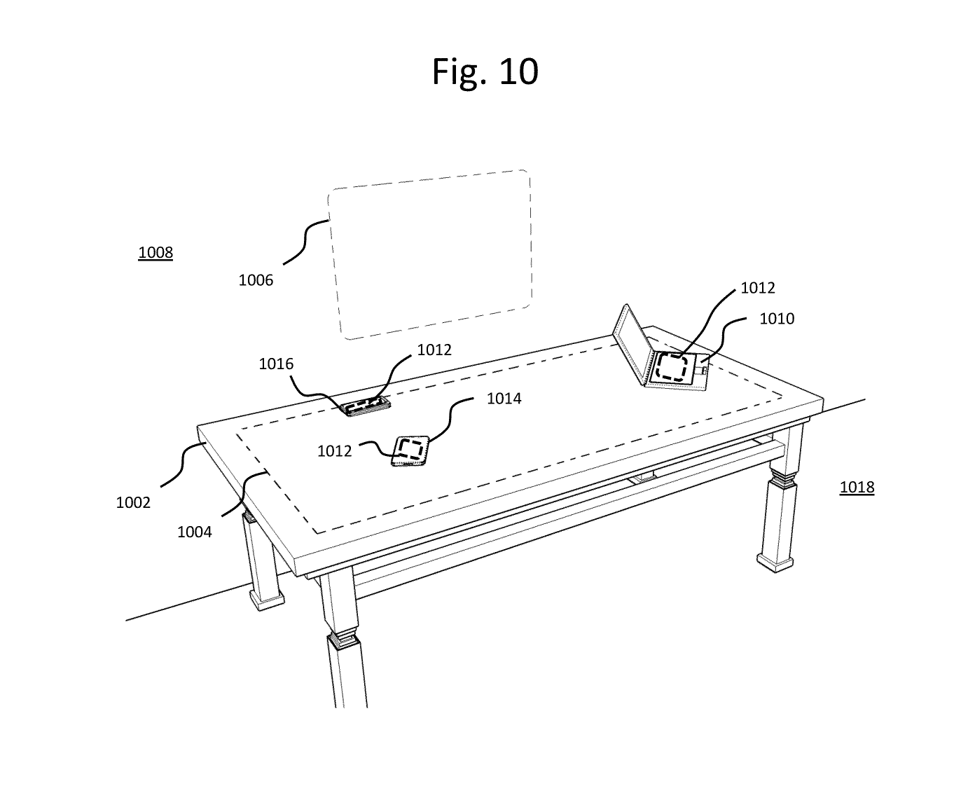

In some embodiments multiple repeater resonators may be used to extend the wireless power transfer into multiple directions or multiple repeater resonators may one after another to extend the power transfer distance as shown in FIG. 9A. In some embodiments, a device resonator that is connected to load or electronic device may operate simultaneously or alternately as a repeater resonator for another device, repeater resonator, or device resonator as shown in FIG. 9B. Note that there is no theoretical limit to the number of resonators that may be used in a given system or operating scenario, but there may be practical issues that make a certain number of resonators a preferred embodiment. For example, system cost considerations may constrain the number of resonators that may be used in a certain application. System size or integration considerations may constrain the size of resonators used in certain applications.

In some embodiments the repeater resonator may have dimensions, size, or configuration that is the same as the source or device resonators. In some embodiments the repeater resonator may have dimensions, size, or configuration that is different than the source or device resonators. The repeater resonator may have a characteristic size that is larger than the device resonator or larger than the source resonator, or larger than both. A larger repeater resonator may improve the coupling between the source and the repeater resonator at a larger separation distance between the source and the device.

In some embodiments two or more repeater resonators may be used in a wireless power transfer system. In some embodiments two or more repeater resonators with two or more sources or devices may be used.

Repeater Resonator Modes of Operation

A repeater resonator may be used to enhance or improve wireless power transfer from a source to one or more resonators built into electronics that may be powered or charged on top of, next to, or inside of tables, desks, shelves, cabinets, beds, television stands, and other furniture, structures, and/or containers. A repeater resonator may be used to generate an energized surface, volume, or area on or next to furniture, structures, and/or containers, without requiring any wired electrical connections to a power source. A repeater resonator may be used to improve the coupling and wireless power transfer between a source that may be outside of the furniture, structures, and/or containers, and one or more devices in the vicinity of the furniture, structures, and/or containers.

In one exemplary embodiment depicted in FIG. 10, a repeater resonator 1004 may be used with a table surface 1002 to energize the top of the table for powering or recharging of electronic devices 1010, 1016, 1014 that have integrated or attached device resonators 1012. The repeater resonator 1004 may be used to improve the wireless power transfer from the source 1006 to the device resonators 1012.

In some embodiments the power source and source resonator may be built into walls, floors, dividers, ceilings, partitions, wall coverings, floor coverings, and the like. A piece of furniture comprising a repeater resonator may be energized by positioning the furniture and the repeater resonator close to the wall, floor, ceiling, partition, wall covering, floor covering, and the like that includes the power source and source resonator. When close to the source resonator, and configured to have substantially the same resonant frequency as the source resonator, the repeater resonator may couple to the source resonator via oscillating magnetic fields generated by the source. The oscillating magnetic fields produce oscillating currents in the conductor loops of the repeater resonator generating an oscillating magnetic field, thereby extending, expanding, reorienting, concentrating, or changing the range or direction of the magnetic field generated by the power source and source resonator alone. The furniture including the repeater resonator may be effectively “plugged in” or energized and capable of providing wireless power to devices on top, below, or next to the furniture by placing the furniture next to the wall, floor, ceiling, etc. housing the power source and source resonator without requiring any physical wires or wired electrical connections between the furniture and the power source and source resonator. Wireless power from the repeater resonator may be supplied to device resonators and electronic devices in the vicinity of the repeater resonator. Power sources may include, but are not limited to, electrical outlets, the electric grid, generators, solar panels, fuel cells, wind turbines, batteries, super-capacitors and the like.

In embodiments, a repeater resonator may enhance the coupling and the efficiency of wireless power transfer to device resonators of small characteristic size, non-optimal orientation, and/or large separation from a source resonator. As described above in this document, the efficiency of wireless power transfer may be inversely proportional to the separation distance between a source and device resonator, and may be described relative to the characteristic size of the smaller of the source or device resonators. For example, a device resonator designed to be integrated into a mobile device such as a smart phone 1012, with a characteristic size of approximately 5 cm, may be much smaller than a source resonator 1006, designed to be mounted on a wall, with a characteristic size of 50 cm, and the separation between these two resonators may be 60 cm or more, or approximately twelve or more characteristic sizes of the device resonator, resulting in low power transfer efficiency. However, if a 50 cm×100 cm repeater resonator is integrated into a table, as shown in FIG. 10, the separation between the source and the repeater may be approximately one characteristic size of the source resonator, so that the efficiency of power transfer from the source to the repeater may be high. Likewise, the smart phone device resonator placed on top of the table or the repeater resonator, may have a separation distance of less than one characteristic size of the device resonator resulting in high efficiency of power transfer between the repeater resonator and the device resonator. While the total transfer efficiency between the source and device must take into account both of these coupling mechanisms, from the source to the repeater and from the repeater to the device, the use of a repeater resonator may provide for improved overall efficiency between the source and device resonators.

In embodiments, the repeater resonator may enhance the coupling and the efficiency of wireless power transfer between a source and a device if the dipole moments of the source and device resonators are not aligned or are positioned in non-favorable or non-optimal orientations. In the exemplary system configuration depicted in FIG. 10, a capacitively loaded loop source resonator integrated into the wall may have a dipole moment that is normal to the plane of the wall. Flat devices, such as mobile handsets, computers, and the like, that normally rest on a flat surface may comprise device resonators with dipole moments that are normal to the plane of the table, such as when the capacitively loaded loop resonators are integrated into one or more of the larger faces of the devices such as the back of a mobile handset or the bottom of a laptop. Such relative orientations may yield coupling and the power transfer efficiencies that are lower than if the dipole moments of the source and device resonators were in the same plane, for example. A repeater resonator that has its dipole moment aligned with that of the dipole moment of the device resonators, as shown in FIG. 10, may increase the overall efficiency of wireless power transfer between the source and device because the large size of the repeater resonator may provide for strong coupling between the source resonator even though the dipole moments of the two resonators are orthogonal, while the orientation of the repeater resonator is favorable for coupling to the device resonator.

In the exemplary embodiment shown in FIG. 10, the direct power transfer efficiency between a 50 cm×50 cm source resonator 1006 mounted on the wall and a smart-phone sized device resonator 1012 lying on top of the table, and approximately 60 cm away from the center of the source resonator, with no repeater resonator present, was calculated to be approximately 19%. Adding a 50 cm×100 cm repeater resonator as shown, and maintaining the relative position and orientation of the source and device resonators improved the coupling efficiency from the source resonator to the device resonator to approximately 60%. In this one example, the coupling efficiency from the source resonator to the repeater resonator was approximately 85% and the coupling efficiency from the repeater resonator to the device resonator was approximately 70%. Note that in this exemplary embodiment, the improvement is due both to the size and the orientation of the repeater resonator.

In embodiments of systems that use a repeater resonator such as the exemplary system depicted in FIG. 10, the repeater resonator may be integrated into the top surface of the table or furniture. In other embodiments the repeater resonator may be attached or configured to attach below the table surface. In other embodiments, the repeater resonator may be integrated in the table legs, panels, or structural supports. Repeater resonators may be integrated in table shelves, drawers, leaves, supports, and the like. In yet other embodiments the repeater resonator may be integrated into a mat, pad, cloth, potholder, and the like, that can be placed on top of a table surface. Repeater resonators may be integrated into items such as bowls, lamps, dishes, picture frames, books, tchotchkes, candle sticks, hot plates, flower arrangements, baskets, and the like.

In embodiments the repeater resonator may use a core of magnetic material or use a form of magnetic material and may use conducting surfaces to shape the field of the repeater resonator to improve coupling between the device and source resonators or to shield the repeater resonators from lossy objects that may be part of the furniture, structures, or containers.

In embodiments, in addition to the exemplary table described above, repeater resonators may be built into chairs, couches, bookshelves, carts, lamps, rugs, carpets, mats, throws, picture frames, desks, counters, closets, doors, windows, stands, islands, cabinets, hutches, fans, shades, shutters, curtains, footstools, and the like.

In embodiments, the repeater resonator may have power and control circuitry that may tune the resonator or may control and monitor any number of voltages, currents, phases, temperature, fields, and the like within the resonator and outside the resonator. The repeater resonator and the power and control circuitry may be configured to provide one or more modes of operation. The mode of operation of the repeater resonator may be configured to act only as repeater resonator. In other embodiments the mode of operation of the repeater resonator may be configured to act as a repeater resonator and/or as a source resonator. The repeater resonator may have an optional power cable or connector allowing connection to a power source such as an electrical outlet providing an energy source for the amplifiers of the power and control circuits for driving the repeater resonator turning it into a source if, for example, a source resonator is not functioning or is not in the vicinity of the furniture. In other embodiments the repeater resonator may have a third mode of operation in which it may also act as a device resonator providing a connection or a plug for connecting electrical or electronic devices to receive DC or AC power captured by the repeater resonator. In embodiments these modes be selected by the user or may be automatically selected by the power and control circuitry of the repeater resonator based on the availability of a source magnetic field, electrical power connection, or a device connection.

In embodiments the repeater resonator may be designed to operate with any number of source resonators that are integrated into walls, floors, other objects or structures. The repeater resonators may be configured to operate with sources that are retrofitted, hung, or suspended permanently or temporarily from walls, furniture, ceilings and the like.

Although the use of a repeater resonator with furniture has been described with the an exemplary embodiment depicting a table and table top devices it should be clear to those skilled in the art that the same configurations and designs may be used and deployed in a number of similar configurations, furniture articles, and devices. For example, a repeater resonator may be integrated into a television or a media stand or a cabinet such that when the cabinet or stand is placed close to a source the repeater resonator is able to transfer enough energy to power or recharge electronic devices on the stand or cabinet such as a television, movie players, remote controls, speakers, and the like.

In embodiments the repeater resonator may be integrated into a bucket or chest that can be used to store electronics, electronic toys, remote controls, game controllers, and the like. When the chest or bucket is positioned close to a source the repeater resonator may enhance power transfer from the source to the devices inside the chest or bucket with built in device resonators to allow recharging of the batteries.

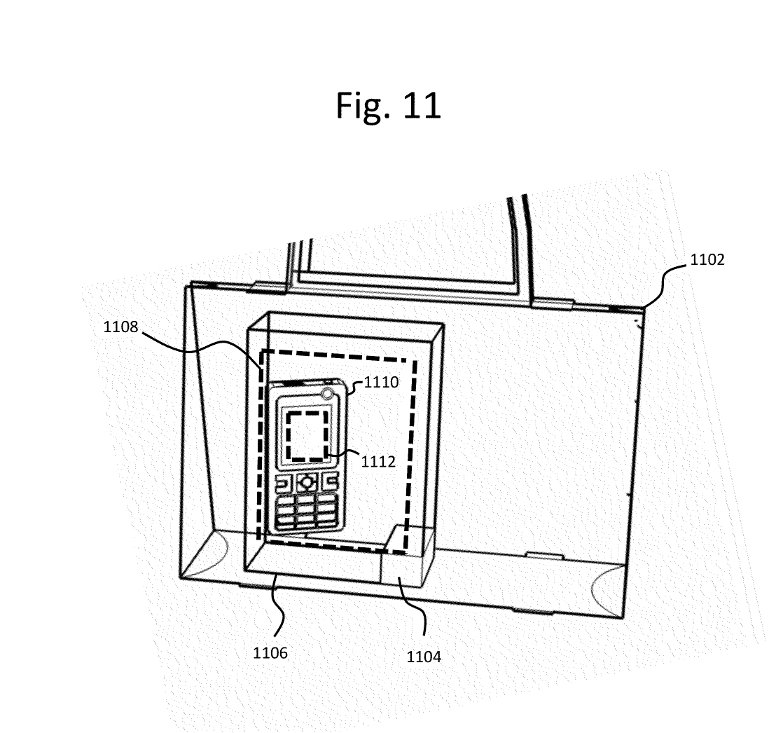

Another exemplary embodiment showing the use of a repeater resonator is depicted in FIG. 11. In this embodiment the repeater resonator may be used in three different modes of operation depending on the usage and state of the power sources and consumers in the arrangement. The figure shows a handbag 1102 that is depicted as transparent to show internal components. In this exemplary embodiment, there may be a separate bag, satchel, pocket, or compartment 1106 inside the bag 1102 that may be used for storage or carrying of electronic devices 1110 such as cell-phones, MP3 players, cameras, computers, e-readers, iPads, tablets, netbooks, and the like. The compartment may be fitted with a resonator 1108 that may be operated in at least three modes of operation. In one mode, the resonator 1108 may be coupled to power and control circuitry that may include rechargeable or replaceable batteries or battery packs or other types of portable power supplies 1104 and may operate as a wireless power source for wirelessly recharging or powering the electronic devices located in the handbag 1102 or the handbag compartment 1106. In this configuration and setting, the bag and the compartment may be used as a portable, wireless recharging or power station for electronics.

The resonator 1108 may also be used as a repeater resonator extending the wireless power transfer from an external source to improve coupling and wireless power transfer efficiency between the external source and source resonator (not shown) and the device resonators 1112 of the device 1110 inside the bag or the compartment. The repeater resonator may be larger than the device resonators inside the bag or the compartment and may have improved coupling to the source.

In another mode, the resonator may be used as a repeater resonator that both supplies power to electronic devices and to a portable power supply used in a wireless power source. When positioned close to an external source or source resonator the captured wireless energy may be used by a repeater resonator to charge the battery 1104 or to recharge the portable energy source of the compartment 1106 allowing its future use as a source resonator. The whole bag with the devices may be placed near a source resonator allowing both recharging of the compartment battery 1104 and the batteries of the devices 1110 inside the compartment 1106 or the bag 1102.

In embodiments the compartment may be built into a bag or container or may be an additional or independent compartment that may be placed into any bag or storage enclosure such as a backpack, purse, shopping bag, luggage, device cases, and the like.

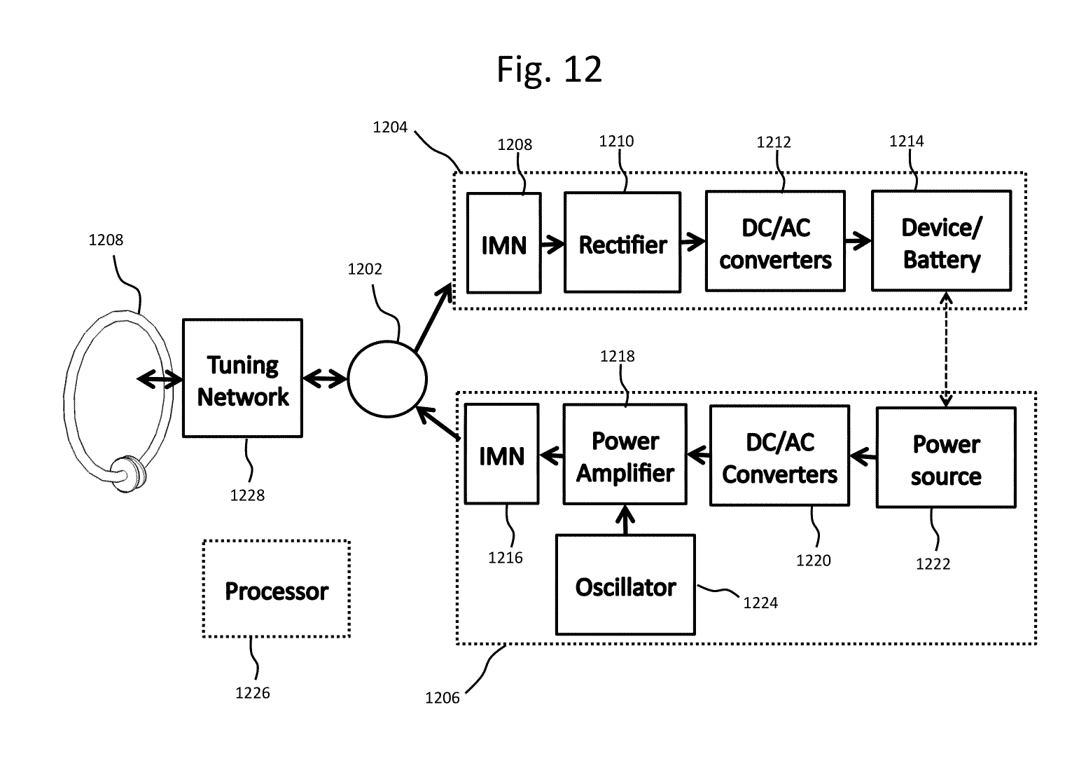

In embodiments, the resonator may comprise switches that couple the power and control circuitry into and out of the resonator circuit so that the resonator may be configured only as a source resonator, only as a repeater resonator, or simultaneously or intermittently as any combination of a source, device and repeater resonator. An exemplary block diagram of a circuit configuration capable of controlling and switching a resonator between the three modes of operation is shown in FIG. 12. In this configuration a capacitively loaded conducting loop 1208 is coupled to a tuning network 1228 to form a resonator. The tuning network 1228 may be used to set, configure, or modify the resonant frequency, impedance, resistance, and the like of the resonator. The resonator may be coupled to a switching element 1202, comprising any number of solid state switches, relays, and the like, that may couple or connect the resonator to either one of at least two circuitry branches, a device circuit branch 1204 or a source circuit branch 1206, or may be used to disconnect from any of the at least two circuit branches during an inactive state or for certain repeater modes of operation. A device circuit branch 1204 may be used when the resonator is operating in a repeater or device mode. A device circuit branch 1204 may convert electrical energy of the resonator to specific DC or AC voltages required by a device, load, battery, and the like and may comprise an impedance matching network 1208, a rectifier 1210, DC to DC or DC to AC converters 1210, and any devices, loads, or batteries requiring power 1214. A device circuit branch may be active during a device mode of operation and/or during a repeater mode of operation. During a repeater mode of operation, a device circuit branch may be configured to drain some power from the resonator to power or charge a load while the resonator is simultaneously repeating the oscillating magnetic fields from an external source to another resonator.

A source circuit branch 1206 may be used during repeater and/or source mode of operation of the resonator. A source circuit branch 1206 may provide oscillating electrical energy to drive the resonator to generate oscillating magnetic fields that may be used to wirelessly transfer power to other resonators. A source circuit branch may comprise a power source 1222, which may be the same energy storage device such as a battery that is charged during a device mode operation of the resonator. A source circuit branch may comprise DC to AC or AC to AC converters 1220 to convert the voltages of a power source to produce oscillating voltages that may be used to drive the resonator through an impedance matching network 1216. A source circuit branch may be active during a source mode of operation and/or during a repeater mode of operation of the resonator allowing wireless power transfer from the power source 1222 to other resonators. During a repeater mode of operation, a source circuit branch may be used to amplify or supplement power to the resonator. During a repeater mode of operation, the external magnetic field may be too weak to allow the repeater resonator to transfer or repeat a strong enough field to power or charge a device. The power from the power source 1222 may be used to supplement the oscillating voltages induced in the resonator 1208 from the external magnetic field to generate a stronger oscillating magnetic field that may be sufficient to power or charge other devices.

In some instances, both the device and source circuit branches may be disconnected from the resonator. During a repeater mode of operation the resonator may be tuned to an appropriate fixed frequency and impedance and may operate in a passive manner. That is, in a manner where the component values in the capacitively loaded conducting loop and tuning network are not actively controlled. In some embodiments, a device circuit branch may require activation and connection during a repeater mode of operation to power control and measurement circuitry used to monitor, configure, and tune the resonator.

In embodiments, the power and control circuitry of a resonator enabled to operate in multiple modes may include a processor and measurement circuitry, such as analog to digital converters and the like, in any of the components or sub-blocks of the circuitry, to monitor the operating characteristics of the resonator and circuitry. The operating characteristics of the resonator may be interpreted and processed by the processor to tune or control parameters of the circuits or to switch between modes of operation. Voltage, current, and power sensors in the resonator, for example, may be used to determine if the resonator is within a range of an external magnetic field, or if a device is present, to determine which mode of operation and which circuit branch to activate.

It is to be understood that the exemplary embodiments described and shown having a repeater resonator were limited to a single repeater resonator in the discussions to simplify the descriptions. All the examples may be extended to having multiple devices or repeater resonators with different active modes of operation.

### Wirelessly Powered Audio Devices

Audio devices that have the ability to be powered and/or recharged wirelessly may increase the utility and/or reliability of such devices. Wirelessly powered audio devices may provide important safety benefits in many environments, such as industrial environments and airplane environments as described above.

Audio devices, which may include headphones, headsets, speakers, portable speakers, hands free headsets, audio and video consoles, person worn heads-up displays, and the like, may be directly powered or may be recharged wirelessly. In this disclosure, embodiments and examples may be described with relation to a specific audio device, or type of device. It is to be understood that unless it is specifically stated otherwise, the techniques, designs, and methods described for a specific audio device may be configured or adapted for other devices, environments, systems, and methods.

Device resonator structures, source resonator structures, repeater resonator structures, power and control circuitry, and control methods and algorithms described herein may be used by the systems, methods, and devices configured for powering and/or recharging audio devices wirelessly. In some embodiments, device resonators may be integrated or attached to the audio devices, the device resonators may be configured with device power and control circuitry to convert energy from oscillating magnetic fields into electrical energy. The electrical energy may be used to directly power the audio devices and/or recharge the batteries of the audio device.

In some embodiments, audio devices may be configured to receive energy via oscillating magnetic fields wirelessly from one or more source resonators. In some embodiments repeater resonators may be used in the devices and system to improve the wireless energy transfer between the audio device and the one or more source resonators.

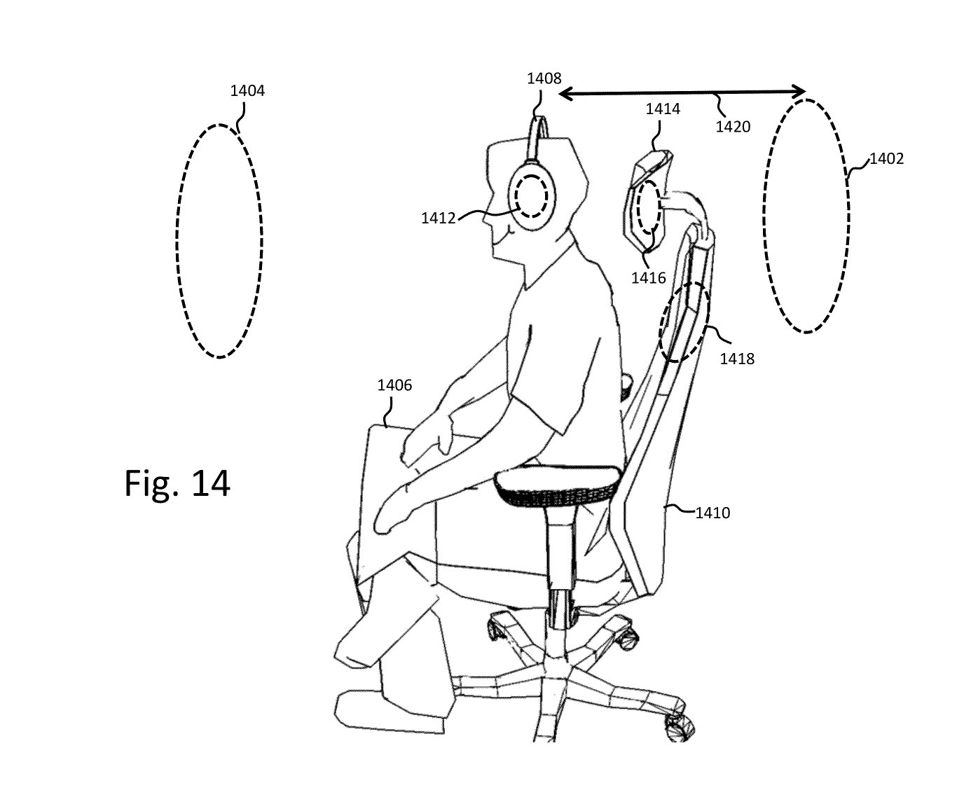

FIG. 14 depicts a system with wirelessly powered headphones 1408 which may be powered and/or recharged wirelessly from source resonators and/or via one or more repeater resonators. In the example system, headphones 1408 that may be worn by a person 1406 may be integrated with one or more device resonators 1412 and device power and control circuitry (not shown). The device resonators 1412 may be integrated into the cups of the headphones 1408, in the bridge of the headphones, and/or other parts that may be sized and shaped to accommodate a resonator. In one embodiment of the system, one or more source resonators 1416, 1418 may be attached or integrated into the chair 1410 used by the user. One or more source resonators 1416, 1418 may be integrated or attached to the headrest, back rest, seat, and the like of the chair 1410. The source resonators may be coupled to source power and control circuitry and may be powered from larger batteries, connected to outlet mains, or powered by any energy sources and/or power supplied described in this disclosure.

In some embodiments of the system depicted in FIG. 14, one or more of the resonators 1416, 1418 attached or integrated into the seat may be repeater resonators. The repeater resonators may be sized, positioned, and configured to improve the coupling between one or more source resonators that may integrated or attached to the chair and/or positioned near the chair and the device resonator(s). Source resonators 1404, 1402 may be, for example, positioned or integrated into furniture, walls, ceilings, monitors, televisions, and other items. In an office environment, for example, a source resonator may be attached or integrated into a wall or a cubical panel next to the chair. The source resonator may be energized by energy from the mains. The source resonators 1402, 1404 may be directly coupled to the device resonators 1412 of the headphones 1408 and/or couple via one or more repeater resonators 1416, 1418 that may be near the headphones and/or integrated or attached to the chair 1410. Source resonators 1402, 1404 may be positioned in front of the user, in back of the user, and/or above or below the user.

Different positions of source and repeater resonators may be appropriate for different environments and use applications. In transportation applications, such as airplanes, buses, cars, boats, and the like, for example, a chair may stay in a fixed location relative to a vehicle and therefore resonators that may be attached or integrated into the seat may be source resonators as the resonators may be easily wired to receive energy from the vehicles energy source.

In other embodiments, such as office environments and, for example, customer support centers or call centers, audio devices such as headphones and telephone headsets may be worn by users sitting on mobile or movable chairs. Movable chairs may make it difficult or impractical to integrate source resonators into the chair. In some embodiments, source resonators may be attached or embedded into stationary objects such as cubicle walls, for example, where power from the mains can be used to directly energize the source resonators. In some embodiments of the system, repeater resonators may be movable and configurable. Repeater resonators may be integrated or packaged such that they may be attached to walls, chairs, furniture, and the like to improve coupling to the device resonators in different environments. In an exemplary embodiment, a chair or seat may itself be wirelessly powered via a source installed on a wall, floor, ceiling, furniture, and the like. The energy captured by a device in the chair or seat may be used to energize an element of the chair, such as a resistive component that may warm or heat the chair. In some embodiments, audio devices such as speakers may be integrated into the chair or seat, such as in a theater or home theater system, and may wirelessly receive energy from a source installed on a wall, floor, ceiling, and the like. In another embodiment, the energy captured by the device in the chair or seat may in turn be used to wirelessly energize an audio device.

In some embodiments, the resonators attached or integrated into the chair or seat may be configured as multi-mode resonators that may operate as source, device, and/or repeater resonators. As described herein, a resonator may be configured to operate with multiple modes. A resonator that is attached to a non-stationary chair may in some instances receive energy from an external source and store the energy in one or more rechargeable batteries that may be attached to the chair. The resonator may act as a repeater in some instances and may be configured to act as a source to power the audio device and may use the energy from the batteries that were charged when the resonator was operating in device mode.

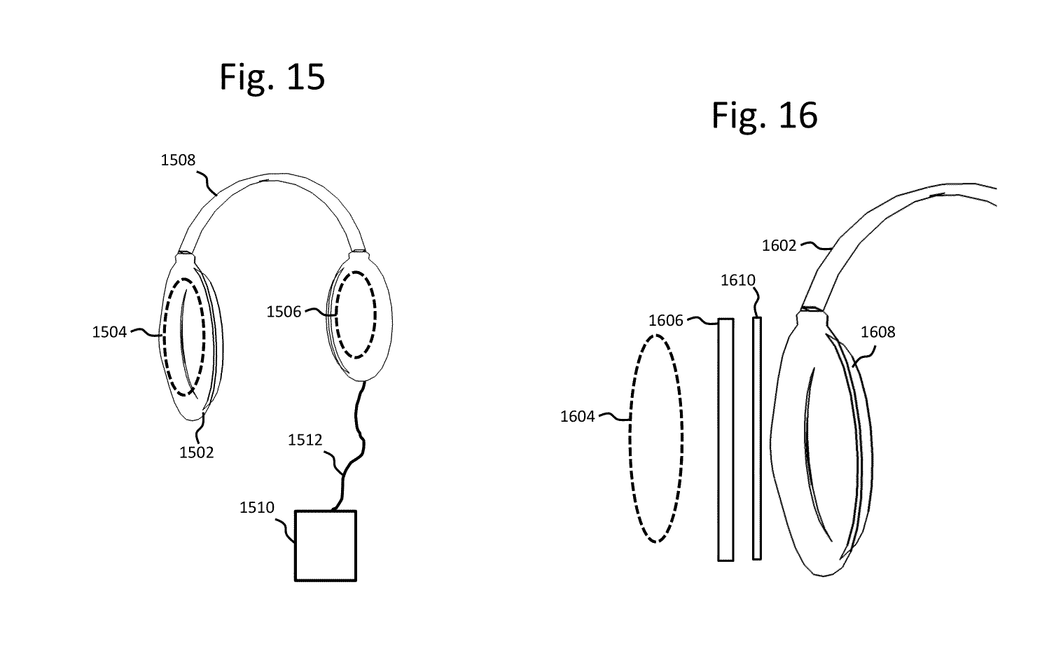

Resonators may be attached or integrated into different components or areas of an audio device. In the example of headphones, as depicted in FIG. 15, device resonators 1504, 1506 may be integrated into the cups 1502 of the headphones. In other embodiments the device resonators and power and control circuitry may be integrated or attached into other elements of the audio devices such as the bridge of the headphones 1508. In some applications, integrating device resonators directly into the audio device may result in a device resonator size or position that is not practical for wireless energy transfer. In some embodiments a pod or dongle or enclosure that houses resonator structures and optionally device power and control circuitry may be remote from the audio device and the energy that is captured by the pod may be transferred to the audio devices via a wired connection. In an exemplary embodiment, the headphones may include a separate pod or dongle 1510 that may be wired 1512 to the headphones. The pod may be detachable from the wire and/or the headphones. In embodiments the pod or dongle 1510 may include one or more device resonators and rechargeable batteries. Energy from the resonators of the pod may be used to recharge the batteries and/or power the headphones. The pod may be worn by the user and may be placed in a pocket, backpack, or positioned for sufficient coupling and energy transfer from one or more source and/or repeater resonators. The pod 1510 may in some embodiments include additional functionality such as a music playback, radio reception and the like. In some embodiments the pod may be used to supplement, or instead of, the energy received by the resonators that may be integrated into the audio devices. For example, when the resonators that may be integrated into the cups of the headphones are not able to receive or capture enough energy to power the headphones, the pod may be attached to provide more energy.

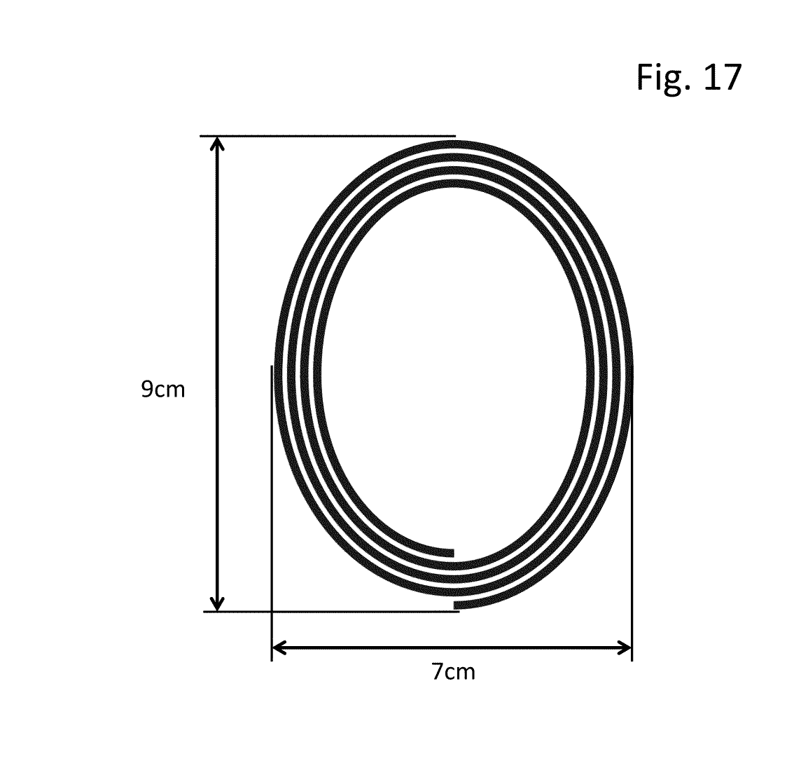

In embodiments, various different resonators sizes, configurations, and types may be used. Capacitively loaded conducting loops, for example, may be integrated or wound into the cups of the headphones. In one embodiment of the headphones, an oval shaped capacitively loaded conducting resonator coil is integrated into the cups of the headphones. The resonator coil, as depicted in an exemplary embodiment in FIG. 17, may be sized and shaped to fit inside the enclosure of the headphones. In some embodiments, the audio devices may include planar resonators, and use magnetic materials to improve coupling to the other resonators of the wireless power transfer system and/or to reduce loss.

Magnetic materials and/or highly conducting materials may be used to shield a resonator coil from lossy materials of the headphone components. FIG. 16 shows an exploded view of a headphone with a resonator coil. Magnetic material 1606 comprising blocks, sheets, powder, and the like may be positioned between the resonator coil 1604 and other electronics or lossy components that may be housed inside the headphone cup 1608. The magnetic material 1606 may be shaped and sized to completely cover the lossy material of the headphones. In some embodiments the magnetic material may only cover specific components and may only partially cover the lossy components and materials of the headphones. In some embodiments, the layer of magnetic material may be sized and shaped to wrap around the resonator coil and may be larger than the resonator coil. In other embodiments the layer of magnetic material may be sized to only cover specific regions or may be limited by weight, for example.

In addition to the layer of magnetic material, or instead of the layer of magnetic material, the device may include a layer of a good electrical conductor 1610 such as copper, aluminum, or the like. The layer of conductor y 1610 may be sized and shaped to cover lossy elements or materials of the headphones. In some embodiments the layer of conductor may be a different shape and size than the layer of magnetic material. In embodiments the layer of the conductor may be larger than the layer of magnetic material. In other embodiments the layer of the conductor may only cover specific regions or areas.

In some embodiments, the position, orientation, and power transfer characteristics of the resonators in the wireless energy transfer system may be designed to reduce or prevent interference with the audio output of the device. Some audio devices may include a diaphragm and an actuator such as a voice coil or a solenoid coil that may be affected by the presence of the magnetic fields of the wireless power system. In some audio devices, the fidelity of the audio may be reduced or noise may be introduced to the audio signals due to the magnetic fields interacting with the actuators and/or other components of the audio device. In embodiments, the position, size, orientation, structure, and operating characteristics or components used for wireless energy transfer may be designed and/or tuned to prevent interference with the audio of the device.

In some embodiments, the frequency of the wireless energy transfer may be selected to prevent or reduce interference with an audio signal. In embodiments, the resonators may be tuned for frequencies above the audible threshold of users and may be tuned to be above 22 kHz or more. In many embodiments the resonant frequency may be selected to be substantially more than 22 kHz and may be as selected to be 200 kHz, 2.26 MHz, 6.78 MHz, 13.56 MHz, or higher. The resonators and the characteristics of the wireless energy transfer systems may be tuned for a narrow operating frequency or a substantially single operating frequency such as to reduce or eliminate harmonics that may interfere with an audio signal. In embodiments the resonators may be configured to a frequency and characteristics such that harmonics or other signals that may fall within the audible frequency range or that may be distorted to produce frequencies that fall within the audio band may have low enough energy component/density so as not interfere with the audio signal at the audible frequencies.

Components that may be sensitive to interference from the magnetic fields used for wireless energy transfer may be shielded and/or the resonators positioned to reduce the strength of the magnetic fields near the sensitive components. In one embodiment the audio device components such as the speakers, voice coils, actuators, amplifiers, drivers, and the like may be shielded from the magnetic fields using a layer of magnetic material and/or a layer of a good electrical conductor such as copper, aluminum, and the like. The sensitive components may be covered, or partially covered by magnetic material and/or the electrical conductor to reduce or substantially eliminate the interaction with the magnetic fields.

In some embodiments, the one or more device resonators that are integrated and/or attached to the audio device may be positioned and/or oriented to reduce the magnetic field strength near the sensitive components. The one or more device resonators, for example, may be positioned and oriented such that the sensitive components of the audio device minimally interfere with the one or more device resonators. One or more resonators may, for example, be positioned and oriented such that the dipole moment of the resonator is orthogonal to the dipole moment of the audio device solenoid. In some embodiments the one or more device resonators may be positioned such that the sensitive components of the audio devices may be offset from the device resonators in a region where the fields near the one or more device resonators are relatively weaker than in other areas.

In some embodiments, wirelessly powered audio devices may include one or more filters configured to filter noise at one or more operating frequencies or harmonics of the wireless energy transfer system. The filters may include tunable band-pass filters configured to filter noise or interference due to the energy transfer. The attenuation, frequency, bandwidth, and the like of the filters may be adjustable based on the parameters of the wireless energy transfer. In some embodiments, the frequencies used for energy transfer may change from one to another and/or may alternate between two or more frequencies. Filters of the audio device may monitor the characteristics of the wireless energy transfer and adjust the filters accordingly. In some embodiments, the parameters of the wireless energy transfer may be received from the power and control circuitry and the frequency response and/or the attenuation of the filters adjusted for these parameters.

In some embodiments, a wirelessly powered audio device may comprise noise evaluation and/or monitor circuitry that may be used to generate control and/or compensation signals to reduce any noise on the audio signals that has been induced by the oscillating magnetic field used for power exchange. The noise monitor signal may be configured to inject additional signals onto the audio signal that may be used to reduce or cancel the noise induced by the oscillating fields of the wireless power system. In some embodiments, the noise evaluation and monitor circuitry may control the audio signal reception circuitry in order to characterize and isolate induced noise signals from desired audio signals. For example, the audio signal receptors may be at least temporarily, or at least intermittently, disconnected from the rest of the audio device circuitry so that a determination can be made as to which signals are noise and which are the desired audio signals. Then, compensating signals may be added to the signal line of the audio device to reduce and/or cancel noise signals. The noise evaluation and/or monitor circuitry may also be used to tune filters, control other electrical components, and control the power transmitted by the wireless power sources and repeaters as described in other sections of this disclosure.

The power demands of the audio devices may be continuously or periodically monitored and the output power of any source resonators and/or repeater resonators of the system may be adjusted to provide adequate power to the audio devices while reducing the strength of the fields. In embodiments, the power output of the source resonators and/or repeater resonators may be controlled to provide no more than 110% of 120% of the required power to power the audio device.

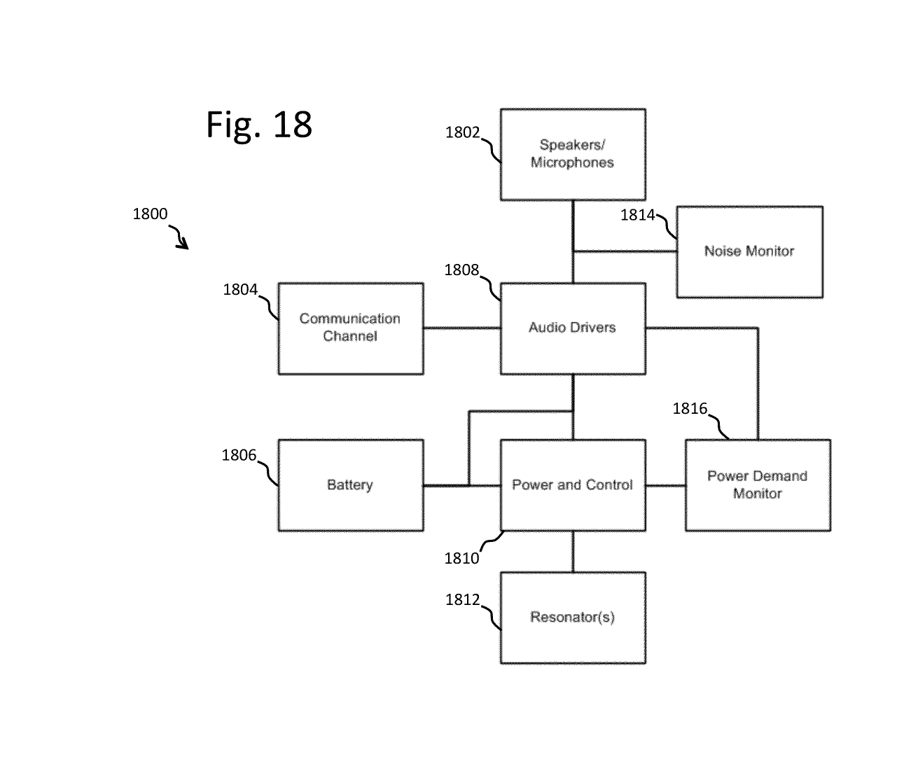

FIG. 18 shows a block diagram of the components of an embodiment of an audio device configured for wireless energy transfer. The wireless audio device 1800 may include speakers, microphones, and or other audio input and/or output actuators or devices 1802. The speakers may be powered or driven by one or more audio drivers 1808 that receive audio and data signals from an internal or external source via a communication channel 1804. The communication channel 1804 may be wired or wireless and may use Bluetooth, WiFi, or other wireless communication technologies and protocols to receive data signals. In some embodiments the communication channel may use near field communications (NFC) and in some cases may use the same fields or components (i.e. resonators) that are used for wireless energy transfer. Energy that may be needed by the audio device may be received by one or more resonators 1812 that may be directly attached/integrated to the audio device or separately wired. The resonators 1812 may include one or more capacitively loaded loop resonators comprising wire or Litz wire, or printed circuit boards. The resonant frequency of the resonators may be controlled by the power and control circuitry 1810. The power and control circuitry may further be configured to provide impedance matching, rectification, and power control. Energy from the power and control circuitry may be used to energize the audio drivers, and other elements of the device. In some embodiments the audio device may include rechargeable batteries 1806. The rechargeable batteries 1806 may be recharged from energy received by the resonators.

The wireless audio device may include a power demand monitor 1816. The power demand monitor 1816 may be used to monitor the power demands of the audio device and adjust the parameters of the wireless energy transfer to increase delivered power if insufficient power is delivered or reduce the power if too much energy is delivered.

In some embodiments, the power demand monitor 1816 may monitor the power demand of the device and the power delivered to the device. If insufficient power is delivered to the device, the power and demand monitor may be configured to trigger an audio notification that may be used to alert the user to adjust the position or other parameters to the improve the wireless energy transfer. The audio notification may include beeps or other sounds to indicate to the user to reduce power usage and/or reposition any of the resonators in the system to improve the energy transfer. The sounds may be used help the user establish the initial configuration of the system, helping the user locate areas and/or positions of source and/or repeater resonators for sufficient energy transfer. In some embodiments, the volume, frequency, and the like of the audible indicators may be related to the field strength or power received by the audio device. The audio device may in some cases be configurable for a diagnostics or “setup” mode where the sounds of the audio device may be used to configure the orientations and locations of source, repeater, and/or device resonators and components.

In some embodiments, a noise monitor 1814 may be used to monitor the interference or noise on the audio output of the device. The noise monitor may be configured to monitor the noise component on one or more frequencies related to wireless energy transfer. The noise monitor may initiate a reduction in the wireless power of any sources and/or repeaters of the wireless power system when the noise reaches a threshold. In some embodiments, when the noise reaches a threshold, one or more filters may be activated. The filters may be bandpass filters at the frequency of the noise component to attenuate the noise. In some embodiments, a noise monitor may initiate active noise cancellation. This may include circuitry to create a signal with phase and amplitude designed to cancel the noise signal. For example, for noise of sinusoidal nature, a cancellation signal or signals may be created with the same amplitude but with phase that is 180 degrees out of phase with the noise signal for destructive interference. In further embodiments, noise cancellation may include circuitry to remove linear and non-linear distortion in an audio signal. Distortion in an audio signal may originate externally to the audio device or internally, such as from the electronics of audio device. The wireless energy transfer system may also induce linear and/or non-linear distortion in the audio signal. Removing distortion may include circuitry to restore the amplitude and phase of an audio signal and/or remove distorting harmonics or interacting frequencies. The noise monitor may activate circuits or other electronics to remove such distortion.

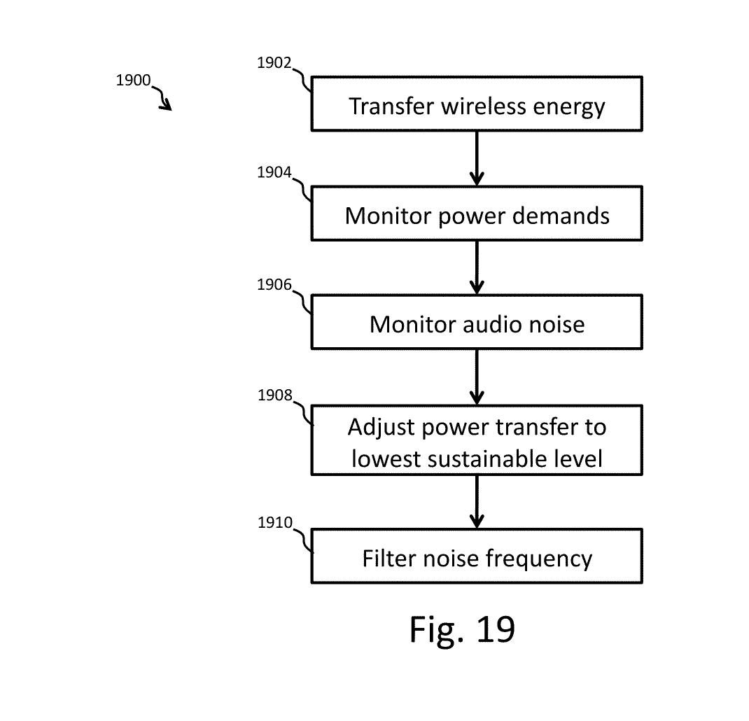

FIG. 19 depicts a method 1900 for controlling the energy transfer for an audio device. In block 1902, the wireless energy transfer may be initiated by a source and/or repeater resonator. In block 1904, the power demand monitor may monitor the power demands of the audio device. In block 1906, the noise monitor may monitor the noise component in the audio signal. In some embodiments, if a noise component is detected, in block 1908 the audio device may signal the source to turn down the output power to a lowest level that still satisfies the power demands of the audio device. In another embodiment, if a noise component is detected, the audio device may change a resonant frequency at which the wireless energy transfer is operating and/or a resonant frequency of a device or source resonator. In yet another embodiment, if a noise component is detected, the audio device may change the dipole moment of a resonator. In block 1910, if noise is still present in the audio signal, filtering of the noise component may be initiated with bandpass filters tuned to filter the frequencies associated with wireless energy transfer.

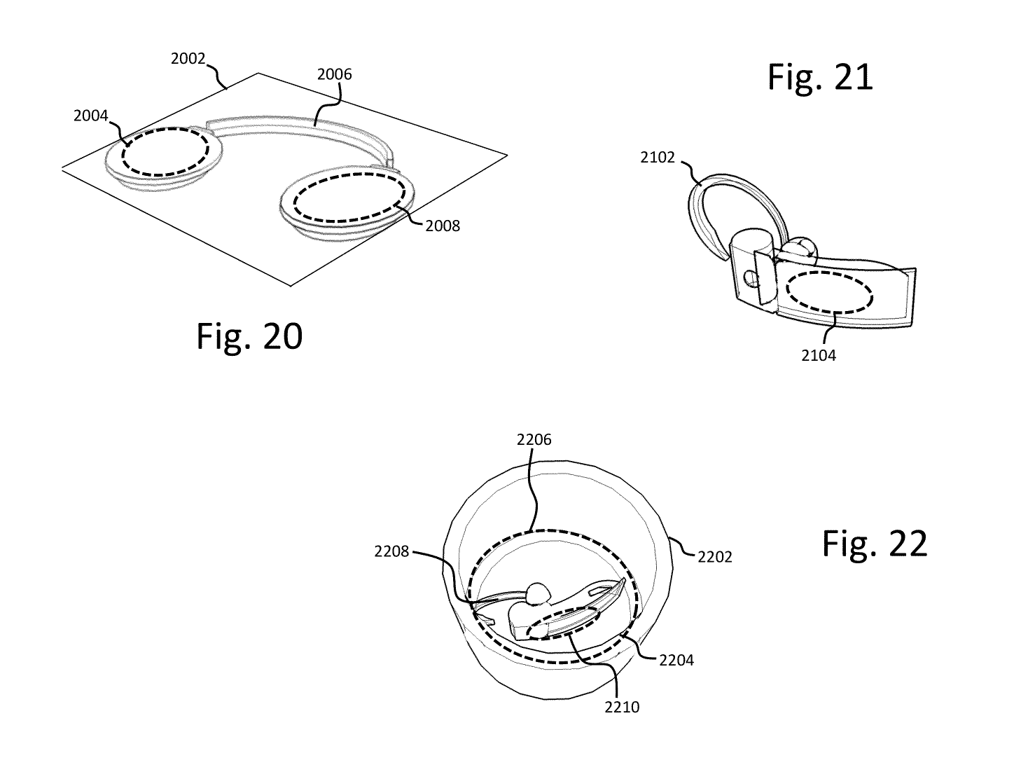

Wireless energy transfer may be used to directly power the audio devices and/or recharge the batteries when in normal use by a user (i.e. sitting in a chair). In some embodiments wireless energy transfer may be used to also recharge the batteries of the audio devices when they are not in use, when the audio devices are placed on a desk, charging pad, carrying case, and the like. In embodiments a wireless energy source may be integrated to a pad, a desk, a stand, a carrying case, and the like. The source may wirelessly transfer power to the resonators of the device when the audio device is placed on or near the source. In one embodiment, as depicted in FIG. 20, a source resonator may be integrated or attached to pad 2002 or a carrying case. Device resonators 2004, 2008 integrated or attached to the headphones 2006 may receive energy from the source and recharge the batteries of the headphones.

Device resonators may be integrated or attached to other audio devices such as a headset depicted in FIG. 21. A headset 2102 may be integrated with a device resonator 2104 and power and control circuitry configured to recharge a battery. When the device resonator is positioned close to a source and/or repeater resonator, the device resonator may recharge the internal battery of the device. In one embodiment, as depicted in FIG. 22, a headset 2208 may be charged in cup shaped container 2202 that has a source resonator 2206 attached to the bottom or sides of the container 2202. The cup shaped container may be used in cup holders in a vehicle or seat, for example. In some embodiments, one or more repeater resonators may be installed into the cup shaped container to deliver wireless energy to the audio devices in the container. In the example of a vehicle, one or more source resonators may be located in the dashboard, center console, side panels, seats, ceiling, and the like of a vehicle and may wirelessly deliver energy to multiple cup shaped containers or other devices within the vehicle.

In one example embodiment of the configuration depicted in FIG. 14, headphones 1408 are integrated with a device resonator 1412. The device resonator coil is wrapped around one of the ear cups and comprises 8 turns of Litz wire formed around a 9 cm by 7 cm ear cup. The power and control electronics are positioned inside the cavity of the headphones. The energy captured by the resonator is converted to DC current by the power and control circuitry and used to power the electronics of the headphones (i.e. noise cancellation circuitry) and also optionally to charge the battery of the headphones. A repeater resonator 1416 is positioned near the headphones. The repeater resonator is shaped to fit around the perimeter of the headrest 1414 of a chair 1410. The repeater resonator is positioned to improve the coupling between a source resonator 1402, positioned behind the chair, and the smaller resonator coil 1412 in the headphones 1408. The repeater resonator 1416 comprises 8 turns of Litz wire forming a 30 cm by 17 cm rectangular shape. The shape and materials of the repeater resonator may be chosen for a 250 kHz operating frequency. In other embodiments the materials and shape of the resonator may be chosen based on the system operating frequency.

A source resonator 1402 comprising six turns of Litz wire wound in a 63 cm by 83 cm enclosure is positioned behind the chair. The source resonator is coupled to an amplifier which drives the resonator with an oscillating current at 250 kHz. In other embodiments the source resonator and amplifier may be optimized or designed for other frequencies, for example, 1 MHz, 2.26 MHz, 6.78 MHz, 13.56 MHz, and the like. For embodiments with other frequencies, the resonator coil may comprise different construction such as a solid wire, etched conductor on a printed circuit board, and the like. The example embodiment of the system depicted in FIG. 14 comprising the source 1402, repeater resonator 1416 and the headphones 1408 delivers about 100 mW of power to the headphones over a distance 1420 of 90 cm. The operation of the headphones (i.e. sound quality, noise cancellation) was not affected by the fields of the wireless energy transfer.

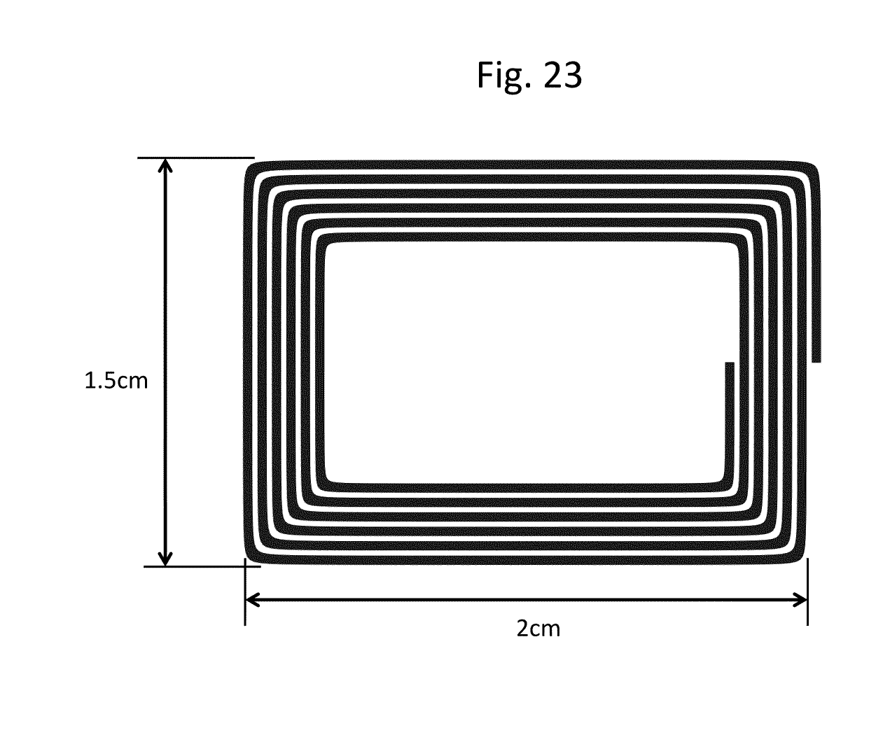

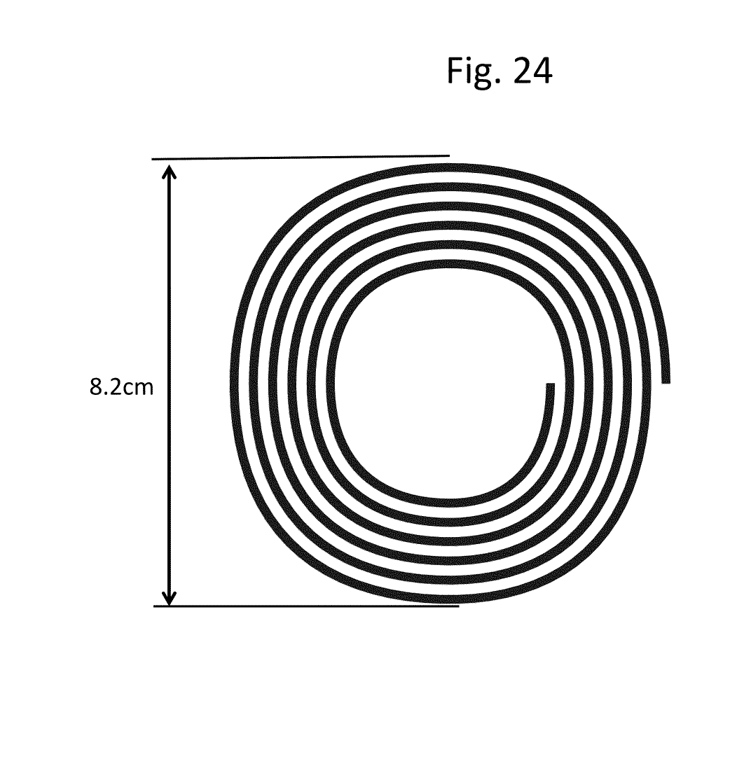

In one embodiment of the configuration shown in FIG. 22, wireless earphones 2208 are charged wirelessly in a cup like container 2202. The earphones have a rechargeable battery and a small resonator 2210 as well as power and control circuitry. The earpiece 2208 is configured to receive 0.35 W of power from the device resonator 2210 integrated into the earpiece. The earphones receive energy from a pad like surface with a circular coil. The system is configured to operate at 6.78 MHz. The source resonator 2206 that is integrated into a cup is capable of recharging multiple earphones simultaneously. The earphones will charge in any orientation with an offset or spacing of up to 6 mm from the source. An exemplary embodiment of the device resonator coil is depicted in FIG. 23 and an exemplary embodiment of the source resonator coil trace is shown in FIG. 24. Both coils are printed on a printed circuit board and designed to operate at 6.78 MHz.

In one example embodiment of the charging configuration shown in FIG. 20, a noise cancelling headphone is configured to be charged from a headphone case or a pad. A wireless energy source is embedded in the headphone pad 2002. The headphones have an integrated resonator 2004 in one of the ear cups. The resonator coil comprises 8 turns of Litz wire forming a 9 cm by 7 cm ellipse. The Litz wire is covered with tiles of magnetic material to shield the resonator from the electronics of the headphones. When the headphones are placed on the pad 2002 the headphones can charge. The headphones can receive 0.1 W of power or more from the source.

Another type of audio device whose performance may be improved and/or enhanced by wireless power transfer capabilities is a hearing aid. A wirelessly powered or charged hearing aid may be self-contained with no wired connections between the hearing aid and the source of power. A wirelessly charged hearing aid may comprise a resonator and/or battery. The battery may be a wirelessly chargeable battery. A wirelessly chargeable battery may be self-contained with no wired connections between the battery and the source of power.

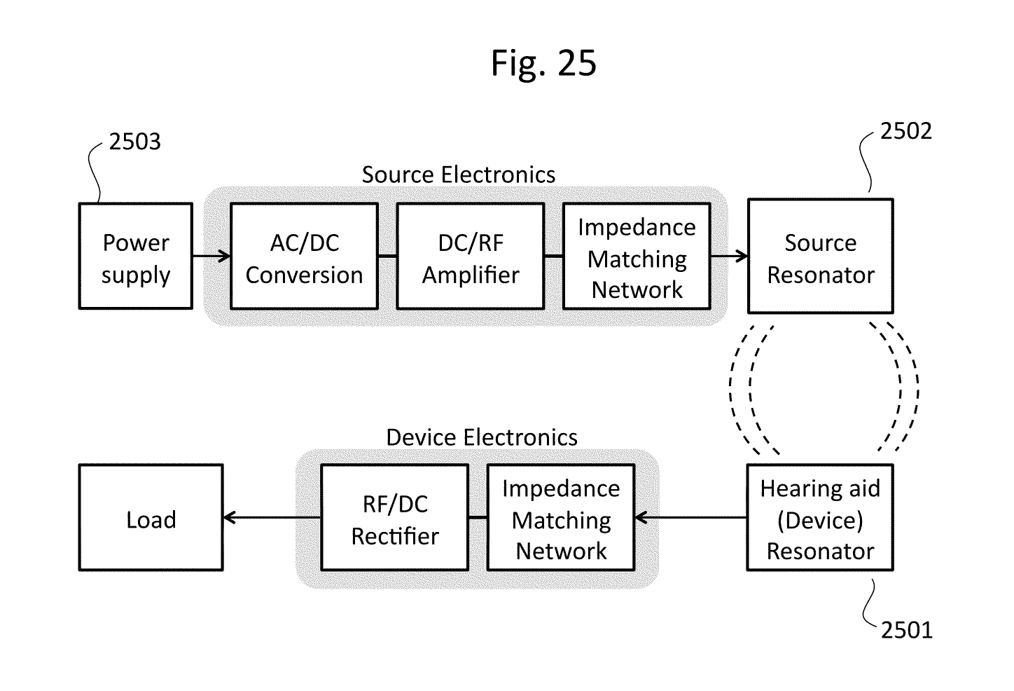

FIG. 25 shows an exemplary embodiment of a wirelessly powered hearing aid system. The hearing aid may comprise a resonator and battery and electronics. The hearing aid may comprise a resonator that may receive power from a wireless energy source. The power received from the wireless energy source may be used to charge a battery encased in the hearing aid. The battery may be a wirelessly chargeable battery. The wireless energy source may comprise a resonator and electronics. The wireless source may be coupled to a power supply 2503 such as AC mains, a battery, a solar panel, a generator, and like. The wireless power transfer system may also comprise multiple source resonators, multiple devices resonators and one or more repeater resonators. These resonators may be arranged to make the wireless recharging of the hearing aid batteries more convenient, more reliable, more energy efficient and the like.

In some embodiments, a single wireless power source may transfer power to at least one wirelessly powered hearing aid and may transfer power to two, or more than two, wirelessly powered hearing aids. The wireless power source may deliver power to the hearing aids in any relative orientation to each other.

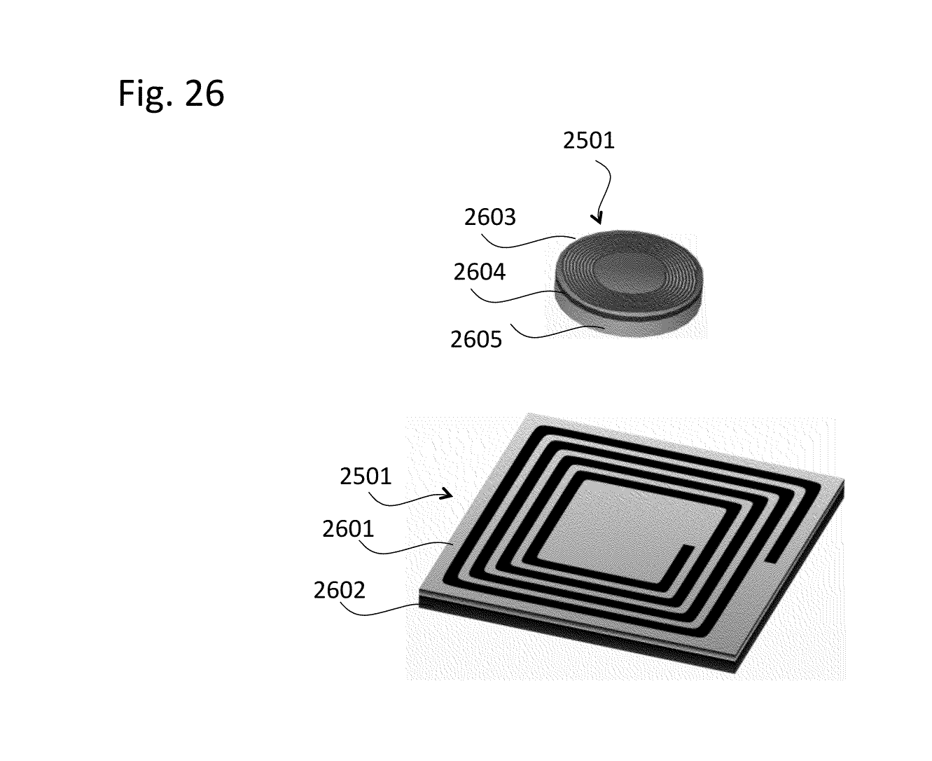

FIG. 26 shows an exemplary embodiment of the resonators on both the device and source side of the wirelessly powered hearing aid system. In preferred embodiments, the source (2501) may comprise a PCB type coil (2601) and a FJ3 type ferrite (2602). In an exemplary embodiment, the source coil has 4 turns. The hearing aid or device (2501) may comprise a PCB type coil (2603) and FJ3 type ferrite (2604) and a highly conducting metal shield (2605). In the exemplary embodiment, a device coil may have 10 turns of a conducting material. The wirelessly powered hearing aid system may couple at a frequency of 6.78 MHz or 13.56 MHz. In embodiments, the device resonator coil may need to be very small so that it can be integrated in the hearing aid. Printed circuit board resonators, potentially made on flexible substrates, may be preferred embodiments for applications where the device receiving wireless power is very small. In such embodiments, the resonant frequency of the magnetic resonators may be designed to be higher than 1 MHz. At higher frequencies, the inductive elements of the resonators may be realized using printed circuit board technology. The capacitive elements of the resonator may be realized using smaller chip capacitors. The capacitive elements may also be realized using capacitive structures integrated using circuit board technology.

In embodiments, a source designed specifically for recharging hearing aids on a pad, in a bowl, in a region, and the like, may be designed to have a power output level between 10 mW, 100 mW and/or 1 W. The distance between the source and hearing aid may be 5 mm. In an exemplary embodiment, the range of coupling factors, k, may be between 0.01 and 0.1.

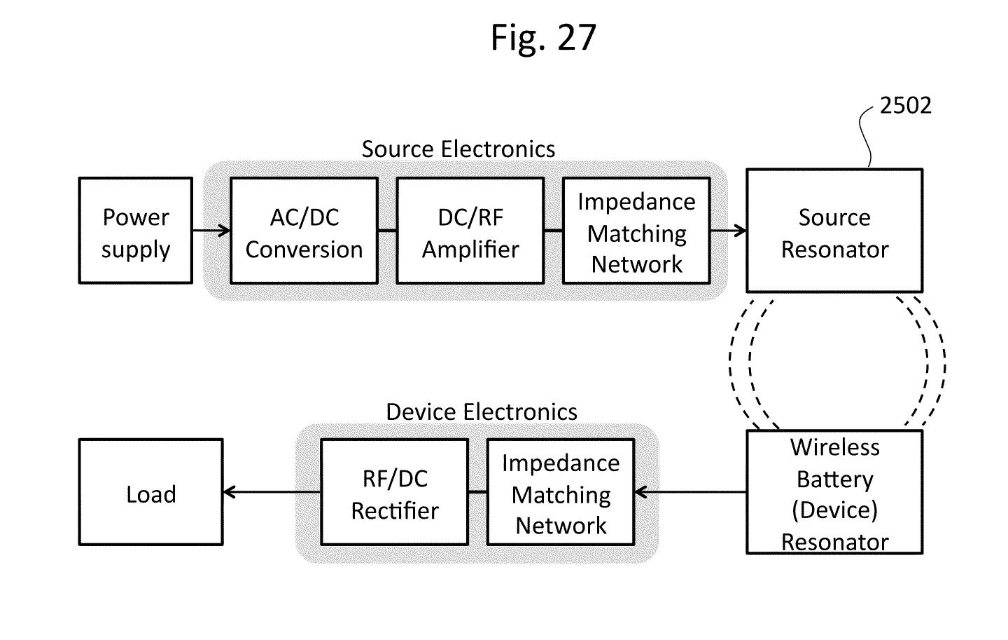

FIG. 27 shows an exemplary embodiment of the wirelessly powered hearing aid system. The hearing aid may comprise a wirelessly chargeable battery. The wirelessly chargeable battery may comprise a resonator and electronics. The battery's electronics may include an impedance matching network and a rectifier.

In some embodiments the wirelessly powered hearing aid system may comprise a source that can charge multiple batteries at any time.

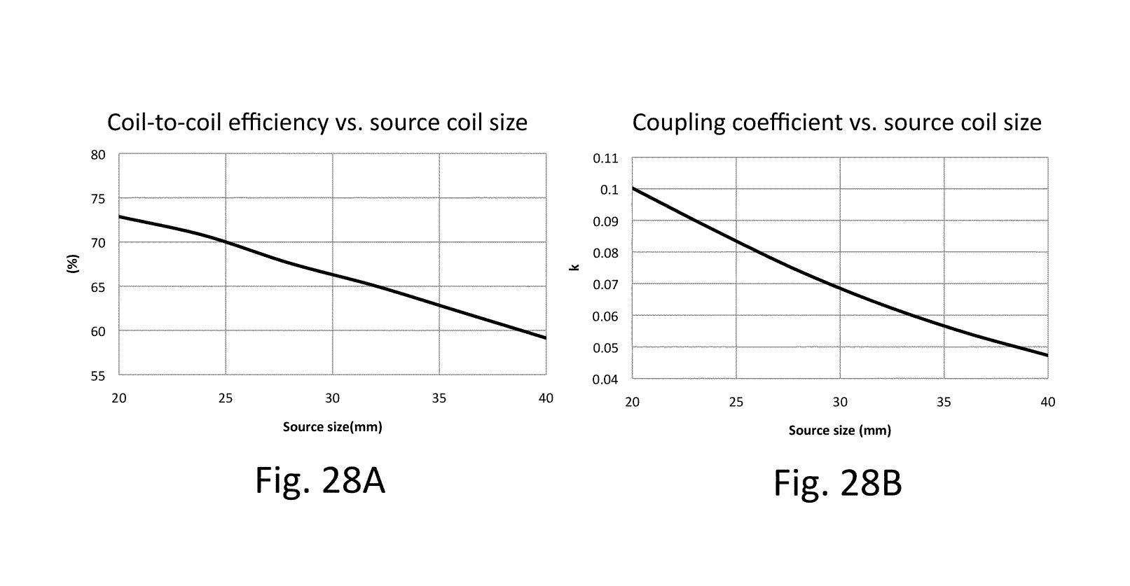

FIGS. 28 A-B show efficiency predictions for an exemplary embodiment of the wirelessly powered hearing aid system. FIG. 28A shows the calculated coil-to-coil efficiency between a wireless power source and a hearing aid device as the size of the source coil is varied from 20 to 40 mm. FIG. 28 B shows the calculated coupling coefficient of the system as the size of the source coil is varied from 20 to 40 mm.

In other embodiments, the wirelessly chargeable hearing aid system may consist of more than one separately encased parts. Each of these encased parts may comprise a resonator, electronics, and a battery. In some embodiments, one of the encased parts may act as a passive resonator or repeater that may couple to both the source and the resonators in the other encased parts of the hearing aid. In some embodiments, some encased parts of the hearing aid system may be implanted inside the user's body. In some embodiments, the passive resonator or repeater may be formed to fit over or around the inside or outside of the ear.

In other embodiments, the wirelessly chargeable hearing aid system may comprise implants such as middle-ear implants or cochlear implants. The user may wear the electronics and/or wirelessly charged battery components elsewhere on their body.

In other embodiments, the wireless power source may be encased in a cup or box shape. This cup or box may be shaped to hold a single hearing aid or two hearing aids or more than two hearing aids.

In other embodiments, the wirelessly powered hearing aid may be charged while worn by the user. The wireless power source may be integrated into the back of a chair or clothing such as a hat so that the hearing aid may be charged while worn by the user. In embodiments, source and/or repeater resonators may be integrated into a structure that resembles over-the-ear head phones, ear muffs or ear warmers. In other embodiments, source and/or repeater resonators may be integrated into hats, caps, scarves, shoulder pads, clothing, and the like, and may be used to charge or power the hearing aids while a person is using them. In embodiments, hearing aids may be powered and/or recharged by the same sources and or repeaters used to power or recharge other audio devices. In embodiments, in-use hearing aid recharging and/or powering systems may preferably comprise at least one repeater resonator.

In embodiments where the hearing aids are being powered directly from a wireless power system, the control, filtering and noise cancellation techniques described for headphones may also be applied to the hearing aids.

In embodiments, recharging of headphones, ear-buds, hearing aids and the like may be accomplished using portable wireless power sources. For example, a wireless power source may receive power from a portable battery that may be stored in a briefcase, a back pack, a hand-bag, a purse, a pocket, a glove compartment, luggage, and the like, and the audio devices may be recharged by placing, dropping, depositing, and the like, them into the briefcase, back pack, hand-bag, purse, pocket, glove compartment, luggage and the like.

It is to be understood that although a specific set of audio devices and environments was used illustrate the devices and methods, the techniques, systems, and devices may be used in a large number of different audio devices and environments. System, devices, and method may be adapted to industrial environments, for example, where noise cancelling headphones may be recharged or powered wirelessly. Transportation, entertainment, and other venues may also employ the techniques.

Unless otherwise indicated, this disclosure uses the terms wireless energy transfer, wireless power transfer, wireless power transmission, and the like, interchangeably. Those skilled in the art will understand that a variety of system architectures may be supported by the wide range of wireless system designs and functionalities described in this application.

This disclosure references certain individual circuit components and elements such as capacitors, inductors, resistors, diodes, transformers, switches and the like; combinations of these elements as networks, topologies, circuits, and the like; and objects that have inherent characteristics such as “self-resonant” objects with capacitance or inductance distributed (or partially distributed, as opposed to solely lumped) throughout the entire object. It would be understood by one of ordinary skill in the art that adjusting and controlling variable components within a circuit or network may adjust the performance of that circuit or network and that those adjustments may be described generally as tuning, adjusting, matching, correcting, and the like. Other methods to tune or adjust the operating point of the wireless power transfer system may be used alone, or in addition to adjusting tunable components such as inductors and capacitors, or banks of inductors and capacitors. Those skilled in the art will recognize that a particular topology discussed in this disclosure can be implemented in a variety of other ways.

Unless otherwise defined, all technical and scientific terms used herein have the same meaning as commonly understood by one of ordinary skill in the art to which this disclosure belongs. In case of conflict with publications, patent applications, patents, and other references mentioned or incorporated herein by reference, the present specification, including definitions, will control.

While the invention has been described in connection with certain preferred embodiments, other embodiments will be understood by one of ordinary skill in the art and are intended to fall within the scope of this disclosure, which is to be interpreted in the broadest sense allowable by law. For example, designs, methods, configurations of components, etc. related to transmitting wireless power have been described above along with various specific applications and examples thereof. Those skilled in the art will appreciate where the designs, components, configurations or components described herein can be used in combination, or interchangeably, and that the above description does not limit such interchangeability or combination of components to only that which is described herein.

All documents referenced herein are hereby incorporated by reference.

We claim:

1. A wirelessly powered audio device comprising:
an audio output element adapted to generate sounds audible to a user;
a device resonator structure adapted to wirelessly receive energy via oscillating magnetic fields, the device resonator configured to reduce the interaction of the magnetic fields with the audio output element; and
a power demand monitor adapted to monitor the power demands of the audio device and the power received via the device resonator structure, the power demand monitor further configured to cause the audio output element to generate an audible signal when the power demands of the audio device exceed the power delivered by the device resonator.

2. The audio device of claim 1, wherein the device resonator structure is positioned near the audio output element such that the audio output device performance is minimally affected by the presence of the device resonator.

3. The audio device of claim 2, wherein the audio output element comprises a solenoid coil and wherein the resonator is positioned such that the dipole moment of the resonator structure is substantially orthogonal to the axis of the solenoid.

4. The audio device of claim 1, further comprising magnetic material, wherein the magnetic material is positioned to shield the audio output element from the magnetic fields near the device resonator structure.

5. The audio device of claim 1, further comprising a sheet of good electrical conducting material, wherein the sheet of good electrical conducting material is positioned to shield the audio output element from the magnetic fields near the device resonator structure.

6. The audio device of claim 1, further comprising rechargeable batteries, wherein energy captured by the device resonator is at least in part used to recharge the batteries.

7. The audio device of claim 1, wherein the device resonator structure comprises capacitively loaded conducting loops printed on a substrate.

8. The audio device of claim 1, wherein the device resonators are integrated in a pod that is wired to the audio device.

9. The audio device of claim 1, wherein the audio device is a headphone.

10. The audio device of claim 1, wherein the audio device is a headset.

11. The audio device of claim 1, wherein the audio device is configured to wirelessly receive energy from a source or repeater resonator in a chair.

12. The audio device of claim 1, wherein the audio device is a hearing aid.

13. A wirelessly powered headphones, the headphones comprising:
a speaker element comprising a diaphragm and an actuator;
a device resonator structure adapted to wirelessly receive energy via oscillating magnetic fields, the device resonator configured to reduce the interaction of the magnetic fields with the speaker element; and
a power demand monitor adapted to monitor the power demands of the headphones and the power received via the device resonator structure, the power demand monitor further configured to cause the speaker element to generate an audible signal when the power demands of the audio device exceed the power delivered by the device resonator.

14. The headphones of claim 13, wherein the speaker element is positioned for minimal performance degradation by the device resonator structure.

15. The headphones of claim 13, further comprising magnetic material, wherein the magnetic material is positioned to shield the speaker element from the magnetic fields near the device resonator structure.

16. The headphones of claim 13, further comprising a sheet of good electrical conducting material, wherein the sheet of good electrical conducting material is positioned to shield the speaker element from the magnetic fields near the device resonator structure.

17. The headphones of claim 13, wherein the headphones are configured to wirelessly receive energy from a source or repeater resonator in a chair.

18. The headphones of claim 13, further comprising rechargeable batteries, wherein energy captured by the device resonator structure is at least in part used to recharge the batteries.

19. The headphones of claim 18, wherein the headphones are configured to be wirelessly recharged from a source resonator embedded in a carrying case.

20. A method for wirelessly powering of an audio device, the method comprising:
initiating wireless energy transfer from a wireless energy source;
monitoring, using a power demand monitor, a power demand of the audio device;
monitoring, using a noise monitor, the noise of an audio signal due to the wireless energy transfer;
adjusting energy transfer to a minimum level that satisfies the power demand of the audio device; and
filtering a noise component from the audio signal.
